(19) United States
(12) Patent Application Publication
(10) Pub. No.: US 2013/0191161 A1
(43) Pub. Date: Jul. 25, 2013

(54) PATIENT DATA INPUT AND ACCESS SYSTEM THAT ENHANCES PATIENT CARE

(71) Applicant: VIMEDICUS, INC., Chicago, IL (US)

(72) Inventors: Robert E. Churchwell, Chicago, IL (US); Thomas L. Churchwell, Winnetka, IL (US); Michael T. Churchwell, Chicago, IL (US); Stephen Wasko, Hinsdale, IL (US); David Donnersberger, Chicago, IL (US); Siri Kumar, Algonquin, IL (US)

(73) Assignee: VIMEDICUS, INC., Chicago, IL (US)

(21) Appl. No.: 13/749,336

(22) Filed: Jan. 24, 2013

Related U.S. Application Data
(60) Provisional application No. 61/590,117, filed on Jan. 24, 2012.

(51) Int. Cl. G06F 19/00; G06Q 50/24

(52) U.S. Cl. CPC G06F 19/3487; G06Q 50/24
USPC 705/3

(57) ABSTRACT

The present disclosure provides a platform for collaborative electronic medical records creation and analysis that provides a more efficient alternative to present EMR systems for healthcare providers. The system includes a server and a user device configured to communicate with one or more EMR or HIE systems. The user device and the server are configured to provide healthcare providers easy access to their patients' data, to accurately collect or receive patient data from healthcare providers, to enable healthcare providers to better collaborate on patient treatment, to automatically provide decision support tools which are based on better quality patient data and statistically significant stored patient data, to enable healthcare providers to better control patient healthcare costs, and to enable healthcare providers to provide better overall patient care.

### PRIORITY CLAIM

This application is a non-provisional application of, and claims priority to and the benefit of U.S. Provisional Patent Application No. 61/590,117, filed Jan. 24, 2012, the entire contents of which are incorporated herein by reference.

### COPYRIGHT NOTICE

A portion of the disclosure of this patent document contains material that is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### BACKGROUND

In the middle of the 20th century, W. Edwards Deming and others recognized that accurate measurement tools and data are key elements to improved quality and cost containment. During the ensuing 50 years, virtually all industries have implemented computerized measurement and data control systems resulting in vastly improved quality and productivity. One of the most notable exceptions is the healthcare industry, which is one of the largest and fastest growing segments of the United States economy. The measurement and data control systems widely implemented in most other segments of the economy are virtually non-existent in the healthcare industry. As a significant part of the United States population ages and consumes even more healthcare resources, the need to implement better quality controls and enhanced data analysis will only continue to grow.

While many industries have substantially integrated software systems (including data capture and data access) into: (a) the daily routines of the workers; (b) the internal operations of the facilities; and (c) the customer, client, and partner interactions, services, and relationships, the healthcare industry has not widely integrated software systems (including patient data capture, patient data access, patient data sharing, and patient care recommendation and decision support systems) into the daily routines of physicians and other healthcare providers. United States government studies show that fewer than 10% of physician practices and fewer than 20% of hospitals make meaningful use of electronic medical records. This often results in a lack of coordinated patient care and consensus among multiple physicians treating the same patient.

More specifically, an electronic medical record (known in the healthcare industry as an “EMR” or “EHR”) is a computerized medical record created by a healthcare provider (such as a physician, nurse, or other healthcare professional, hereinafter referred to as a “healthcare provider” or “provider”) who delivers or assists in the delivery of medical care to a patient. More than 300 companies in the United States currently offer commercial electronic medical record systems (“EMR or EHR systems”). These various known systems enable healthcare providers to input and access certain data regarding a patient's condition and treatment plans and outcomes. Most EMRs were originally created as billing systems enabling providers to charge payers for tests and procedures. As the need for clinical data became apparent, the existing EMR systems were typically retrofitted to enable providers to store clinical patient data in addition to payment information. As a result, EMR systems are not designed to support the workflow of healthcare providers and EMR systems are notoriously difficult for healthcare providers to use. Research data consistently demonstrate that provider reluctance to use EMR systems tracks directly to usability. The average physician uses one or more EMR systems and spends two hours more per day on record keeping once they have installed an EMR “productivity” tool. Installation failure rates approach 50% and practices typically lose 40 to 50% of revenue for 4 to 6 months during installation of an EMR system. This inefficiency not only limits provider usage of the EMR systems, but also causes mistakes and too often forces healthcare providers to take shortcuts to limit the time they spend record keeping. Thus, even the small amount of clinical data that is collected by the known EMR systems is, at best, haphazardly structured and often incomplete. This prevents significant reliance on the patient data stored in such EMR systems for research, measurement, and analysis purposes as is widely done in other industries.

An additional drawback to current EMR systems is the lack of interoperability between different existing EMR systems, which is in part caused by patient data that is stored separately across several disparate systems with inadequate tools for sharing and aggregation. This lack of interoperability prevents fully coordinated patient care. More specifically, each EMR system is designed to store data for a particular provider group (such as a hospital or physician practice group) and few EMR systems easily connect to or communicate with other EMR systems—even in some cases where the EMR systems are from the same EMR system supplier. Thus, physicians who use EMR systems often have their patient electronic medical records resident in multiple EMR systems that are not—and in many cases cannot be—configured to readily, easily, and quickly exchange patient data. While most contemporary EMR systems are beginning to include the capability to communicate to some degree via HL7 standard protocols (or one or more of its derivatives such as C32 Continuity of Care Documents), the institutions that use these systems typically do not communicate with each other and, more importantly, do not enable physicians to readily, easily, and quickly access all of the needed data concerning a patient from these different EMR systems in usable form or at the point and time of patient care (especially when the source of this patient data is different healthcare providers). To add to these problems, many providers practice in multiple hospitals with different EMR systems and must maintain different login credentials for each EMR system and remember how patient data is stored in that EMR system. In other words, a further reason that affiliated or independent healthcare providers resist the adoption of current generation EMR systems is their negative experiences with the multiple different EMR systems with which they must interact on a daily basis.

As indicated above, all of these problems are further multiplied and complicated because patients are often treated by many different physicians at many different practices and at many different hospitals (or other healthcare facilities). This dramatically increases the number of possible different EMR systems in which a patient's data is stored. The present EMR systems do not readily provide the interoperability needed for the physicians and all other healthcare providers treating a patient to view a comprehensive record of all of their combined efforts for that patient.

Further, in an era in which faxes have virtually disappeared from the business world, the average physician's office receives an estimated 1,000 faxes per week. Even if the faxes are electronically transmitted, they are images that cannot be incorporated into patient data that is easily searchable by most EMR systems and are thus not readily accessible by all treating healthcare providers (regardless of the source).

Known EMR systems also create substantial additional work for healthcare providers instead of enabling healthcare providers to incorporate use of these EMR systems into their daily workflow. During a typical day, a primary care physician (sometimes called an “internist” or “GP”) sees numerous patients. During each patient visit, the physician may need to access patient records to view or to enter data. Using a desktop or laptop computer often forces physicians to turn away from their patients while accessing patient records, or imposes a physical barrier between physician and patient. Many physicians and patients feel that the use of an EMR system negatively affects the patient's comfort during an encounter. Additionally, during a typical day, a physician will need access to patient data outside of office hours when they are not near a computer for: (i) emergency patient phone calls; (ii) consultation phone calls from other physicians treating the same patients; and (iii) requests for approval of medication prescriptions. Current EMR systems do not readily and easily enable a physician to access or input patient data when they are in the office and when they are remote from their office. Additionally, toward the end of the typical day, physicians must either sacrifice office time when they could be seeing patients, or spend their free time updating patient records in the EMR system with the information that is required for them to be reimbursed by payers.

Another major impediment to improvement of the quality of healthcare and cost containment in the healthcare industry is what many people believe to be a self-defeating incentive system. Under current reimbursement rules in the United States (which are followed by most insurance companies, Medicare, Medicaid, companies or corporations that self insure, and other healthcare payers), healthcare providers are reimbursed for tests and procedures performed on patients rather than on patient outcomes or, more specifically, positive patient outcomes. This provides inappropriate incentives. Also, many people believe that since the legal system in the United States for practical purposes enables enforcement of healthcare quality control through tort law, healthcare providers are strongly incented to perform more tests and procedures on patients rather than focus on quality outcomes for patients.

Two innovations are being implemented to address the issue of self-defeating or inappropriate incentives, and are starting to rapidly and radically transform the healthcare industry. The first is coordinated care provided by accountable care organizations (“ACO” or “ACOS”), and the second is health information exchanges (“HIE” or “HIEs”). ACOs invert the current incentive system that pays healthcare providers for tests and procedures on patients regardless of the outcomes for those patients. Generally, an ACO is or provides a contract between a group of healthcare providers and a payer (such as a corporation that self insures, an insurance company, Medicare, or Medicaid) that pays the historical cost of serving a cohort or group of patients. Under this contract, if the healthcare providers are able to deliver the same or better quality of care to the cohort or group of patients for less money than the historical cost, they share the savings with the payers. HIEs are systems that collect data from disparate EMR systems and enable authorized users to securely view patient data regardless of which EMR systems are storing the data. Thus, while ACOS attempt to reduce the self-defeating or inappropriate incentives by rewarding outcomes, and HIEs enable certain levels of interconnectivity to permit patient data to flow across data silos, neither also solves the problem of complex, difficult to use, time consuming and uncoordinated data interfaces.

In December 2010, the President's Council of Advisors on Science and Technology (known as “PCAST”) published a report and recommendations on realizing the full potential of health information technology to improve healthcare in the United States. This report confirms the necessity of dramatically increasing usage of EMR systems and making different EMR systems interoperable. Additionally, new United States health care regulations are expected to force all EMR systems to provide for the transmission and receipt of patient data using standard protocols to be eligible for certification. While the EMR systems will be required to provide for communication, there is no requirement for the purchasers of these systems (such as hospitals or other health care systems) to communicate with other health care systems. This means that physicians may have access to multiple electronic health care systems that can, but do not, communicate with each other.

As indicated above, one of the significant problems which results from limited implementation and usage of EMR systems is that the patient data compiled by the relatively small minority of current users of known EMR systems in the healthcare industry is not of sufficient quality or quantity to enable robust measurement, analysis, and other use of the patient data collected and stored on these EMR (and HIE) systems. More specifically, the complexity of known EMR systems often causes healthcare providers to make mistakes in inputting patient data and to take shortcuts in using such EMR systems, thus rendering the stored patient data unsuitable for advanced quality measurement and analysis purposes. The relatively small amount of patient data in these systems as compared to the vast quantity of possible available patient data in the healthcare industry also renders this stored data much less suitable for advanced quality measurement and analysis purposes. Additionally, because current electronic health IT standards (such as HL7) enable a certain amount of flexibility in their implementation, different health care systems using the same standard may have data that is not easily comparable. For example, the HL7 standard enables a custom “Z” section. Many physicians use the “miscellaneous” section to enter notes that do not fit into the rigid structure of their EMR system. These notes are often the clearest, most concise summary of the patient's current condition, but because they are in a “custom” section, other electronic systems are not able to read this data.

An additional problem exists regarding reporting. In addition to the clinical patient data, many payers are now requiring health care providers to record additional data for quality reporting and efficiency measures. Current EMR systems are already struggling to meet the needs of traditional patient records and are not equipped to capture this additional data. For example, the AMA's National Quality Forum has recently approved 113 “eMeasures”. These eMeasures track whether providers are ordering or performing recommended tests or procedures as indicated by certain patient conditions, such as recording a patient's blood pressure when a diagnosis of hypertension has been given. For many payers, especially Medicare, a provider's compliance with these eMeasures will be directly tied to their reimbursement. As these measures change, as more are added, and as other payers begin to introduce their own measures, healthcare providers will need to be able to track their compliance. Currently, this is often done through third-party solutions, such as websites, and requires providers to manually copy the necessary data from their EMR systems—assuming they have one, or that their system is able to record the necessary information.

Another problem is that existing or legacy EMRs are enterprise software systems that are inherently very cumbersome and expensive to update. Since it will be too expensive and too time consuming to completely redo or revamp existing or legacy EMR (and HIE) systems, there is a substantial need to provide systems and devices which enable physicians and other healthcare providers to substantially increase the amount and quality of usage of existing or legacy EMR systems (and/or HIE systems). Providers also want systems that are easily, quickly, and inexpensively updated like the applications on their smart-phones and tablet computing devices.

Accordingly, there is a need to provide systems and devices which: (a) vastly improve the ability to easily and quickly input patient data at the point and time of patient care; (b) vastly improve the ability to easily and quickly access stored patient data in a readily usable format at the point and time of patient care; (c) provide interoperable systems which enable multiple healthcare providers to fully access each patient's data (regardless of the source); (d) provide better healthcare information, recommendations and decision support tools at the point and time of patient care; (e) substantially increase the quality of patient data and the quantity of patient data inputted into and stored in existing or legacy EMR and HIE systems to facilitate better patient healthcare quality measurement, analysis, and management; (f) enable better cost control for patient healthcare; (g) integrate future sources of data, such as patient monitoring devices or pharmacy information into the patient record without the need to modify an existing or legacy EMR system at great expense; and (h) most importantly, provide better overall patient care. There is also a need for such systems and devices to enable physicians and other healthcare providers to use them without disrupting their daily routines and without adding significant amounts time to input patient data at the end of each day of patient care.

### SUMMARY

Various embodiments of the present disclosure provide systems including servers and user devices that solve the above-described problems. The present disclosure generally provides a computerized platform which includes software applications which solve these problems, and an architecture upon which additional software applications may be built, all of which facilitate and provide healthcare providers with coordinated intuitive, workflow-sensitive access to patient data (regardless of source), use of patient data, input of patient data, and synthesis of patient data into easier to understand information, and which further facilitates the potential for future, as-yet undiscovered improvements in the healthcare industry and patient care. More specifically, various embodiments of the present disclosure provide systems including servers and user devices which relatively inexpensively enable healthcare providers (such as physicians) to: (a) simply, quickly, and easily input patient data at the point and time of patient care; (b) simply, quickly, and easily retrieve (from one or more existing or legacy EMR and HIE systems and regardless of the original source) stored patient data in a usable format at the point and time of patient care; (c) simply, quickly, and easily build and customize modular interfaces configured for accessing and input patient data at the point and time of patient care; (d) readily access readily usable patient health condition information derived from these data when combined with technical rules, or algorithms; (e) collaborate with peers such as other healthcare providers on the curating and analysis of the patient data, discussing and documenting patient assessments, and agreeing and implementing common patient treatment plans; (f) access and use a range of recommendation and decision support tools which are based on a higher quality and quantity statistically substantial stored patient data and thus better patient data quality measurement, analysis, and management; (g) better control patient healthcare costs; and (h) most importantly, provide better overall patient healthcare. The system of the present disclosure is configured to communicate with existing or legacy EMR and HIE systems and thus function between the healthcare providers and the existing or legacy EMR and HIE systems, and eliminate or substantially reduce the need for healthcare providers to directly use or interface with existing or legacy EMR systems. The system of the present disclosure also better enables healthcare providers and healthcare payers (such as insurance companies, Medicare, Medicaid, companies or corporations that self-insure, and ACOs) to guide and track patient care and outcomes. The system of the present disclosure can also be configured to facilitate payment for care provided to patients.

Additional features and advantages are described in, and will be apparent from, the following Detailed Description and the figures.

### BRIEF DESCRIPTION OF THE FIGURES

FIG. 1 is a schematic diagram of one example of the communication between the system of one example embodiment of the present disclosure and existing EMR and HIE systems.

FIG. 2 is a schematic diagram of another example of the communication between the system of one example embodiment of the present disclosure and existing EMR and HIE systems.

FIG. 3 is an example Task List interface of the example embodiment of the present disclosure of FIG. 1.

FIG. 4 is an example Pharmacy Review interface for the Medication Renewal interface of the example embodiment of the present disclosure of FIG. 1.

FIG. 5 is an example PEFR Chart interface for the Encounter interface of the example embodiment of the present disclosure of FIG. 1.

FIG. 6 is an example Active Medication interface for the Medications interface of the example embodiment of the present disclosure of FIG. 1.

FIG. 7 is an example Add Medication interface for the Medications interface of the example embodiment of the present disclosure of FIG. 1.

FIG. 8 is an example Update Medication interface for the Medications interface of the example embodiment of the present disclosure of FIG. 1.

FIG. 9 is an example Prescription History interface for the Medications interface of the example embodiment of the present disclosure of FIG. 1.

FIG. 10 is an example Medication Reconciliation interface for the Medications interface of the example embodiment of the present disclosure of FIG. 1.

FIG. 11 is a flowchart of the communication of the alternative embodiment of the present disclosure of FIG. 2.

FIG. 12 is an example filled ePrescription favorites interface for the Medications interface of the example embodiment of the present disclosure of FIG. 2.

FIG. 13 is an example collaborative workflow flowchart which illustrates access and input of patient data by the users of the system of the present disclosure.

FIG. 14 is a flow diagram illustrating an example process for applying best practice decision support to clinical care.

FIG. 15 illustrates an embodiment of a process for coordination and communication among healthcare providers.

### DETAILED DESCRIPTION

For brevity, healthcare providers may sometimes be referred to herein as “care providers” or “providers.” For purposes of this document, healthcare providers include but are not limited to: (i) physicians or medical doctors; (ii) physician assistants; (iii) nurses; and (iv) nurse practitioners Additionally, for purposes of this document, healthcare providers is meant to include the people or staff in a physician's office or who work with or for a physician, hospital, or other healthcare facility which assists in patient data entry and retrieval. Additionally, for brevity, patient data and patient information will be referred to herein as “patient data.”

In various embodiments, the system of the present disclosure provides a user device (such as a mobile telephone or tablet computer configured with one or more applications) which is configured to communicate with at least one server of the system which in turn is configured to communicate with one or more different EMR systems and/or one or more HIE systems (such as existing or legacy EMR or HIE systems). The user device and the server are configured to communicate with and otherwise work with such existing or legacy EMR systems and HIE systems to: (a) provide healthcare providers simple, quick, easy, and complete access to their patients' data in a manner in which the healthcare providers function in their daily routines; (b) simply, quickly, easily, completely, and accurately collect or receive patient data from healthcare providers in a manner in which the healthcare providers function in their daily routines; (c) automatically provide or enable healthcare providers to use different decision support tools which are based on higher quality patient data and statistically significant amounts of stored patient data, and better patient data quality measurement, analysis, and management; (d) enable healthcare providers to better control patient healthcare costs; and (e) enable healthcare providers to provide better overall patient care.

In various embodiments, the system of the present disclosure dramatically reduces the amount of time needed by a provider to directly use traditional or legacy EMR systems, enables a more efficient use of the time spent while using an EMR system, and improves the quality and quantity of data that is provided to EMR systems and thus HIE systems.

The system of the present disclosure largely replaces the need for providers to learn how to install existing or legacy EMR systems, learn how existing or legacy EMR systems work, learn how to input patient data into existing or legacy EMR systems, and learn how to access patient data using exiting or legacy EMR systems, in part by offering a more intuitive interface and embedded applications somewhat similar to those already used by providers on their mobile tablets and smart phones. The present disclosure also enables access to certain tools such as decision support tools in forms such as applications or apps which healthcare providers are more accustomed to.

When used with one or more HIEs, the system of the present disclosure provide access to suitable electronic medical record patient databases by providing the user with an electronic patient data system without requiring any investment in the purchase of, installation of, and training on the use of any EMR system. This enables physicians and other healthcare providers who are otherwise unable (due to time, money or other constraints) or unwilling to employ EMR systems to effectively indirectly use EMR systems and HIE systems and to contribute a greater quantity of electronic medical patient data or EMRs, and more importantly more reliable and higher quality electronic medical patient data or EMRs to EMR systems and thus to HIE systems.

The system of the present disclosure further provides user friendly interfaces (as described below) which take the place of the interfaces provided by the multiple different EMR systems (generally described above) thus reducing or eliminating many of the above described problems and providing interoperability between different legacy EMR systems. The system of the present disclosure also provides quality control on the patient data entered by users at the time of data entry and more specifically at the time of patient treatment which in turn increases quality of patient care as well as quality and quantity of patient data in EMR and HIE systems, which itself in turn facilitates the ability for conducting a higher level of the patient data analysis.

The system of the present disclosure, and more specifically the various user interfaces provided by the server and user device of the present disclosure (which are described in detail below) further enable healthcare providers to more readily, quickly, and easily implement and document patient treatment, and coordinate care of patients by multiple care providers in accordance with the best know procedures for patient care. For example, the system of the present disclosure better enables multiple care providers treating a patient to proceed under what is commonly referred to as the SOAP process. The SOAP process generally includes patient treatment based on: (a) subjective patient data; (b) objective patient data; (c) assessment of such subjective and objective patient data; and (d) a plan based on such assessment. The system of the present disclosure, and particularly the interfaces described below: (a) closely associate or link and provide practically simultaneous access to such subjective patient data by multiple healthcare providers (in the same or different practices, hospitals, etc.); (b) closely associate or link and provide practically simultaneous access to objective patient data by multiple healthcare providers (in the same or different practices, hospitals, etc.); and (c) closely associate or link and provide practically simultaneous access to subjective and objective patient data (regardless of the source of the patient data). The system of the present disclosure, and particularly the interfaces described below, thus enable healthcare providers to: (a) simply, quickly, and easily access each other's subjective and objective patient data; (b) simply, quickly, and easily work together and agree on and document a common assessment; and (c) simply, quickly, and easily implement and document a coordinated treatment plan based on the common assessment.

The various interfaces displayed or provided by the user device of the present disclosure as further described below are configured to be intuitive to the physicians and other healthcare providers so as to become an integral part of their daily routines including their daily care for patients at the point of care and as they provide care for patients, which in turn will encourage physicians and such other healthcare providers to input more patient data, more complete patient data, and more accurate patient data. The entry of more patient data, more complete patient data, and more accurate patient data will lead to a more robust system for use by healthcare providers, which will in turn will lead to even more use of the system and thus an even higher levels of entry of patient data, more complete patient data, and more accurate patient data. Thus, the system will provide for an ever increasing desire for healthcare providers to use the system because the system will continuously improve the effectiveness that the healthcare providers will have in treating patients.

In various embodiments, the system also provides tools to enable the user to configure how patient data is entered. Data capture fields with user-defined data dependencies are available for users to build custom workflows. One example of a custom workflow would be to require that a minimum amount of patient vital signs be recorded before the user can save or submit an encounter. Another example would be to require that quality reporting data be included whenever a specified procedure is entered into the system. In these embodiments, while the system enables the user to customize how data is entered, the data itself is standardized so that any other electronic EMR or HIE system will be able to use the data effectively.

For the toolset described above, the various example interfaces displayed or provided by the user device of the present disclosure as discussed below are to be considered a default or standard configuration that may be easily customized by a user to meet the specific needs of a user's medical specialty, work environment, individual workflow, and specialty patient data. It should thus be appreciated that the system of the present disclosure in various embodiments additionally provides customization tools for building custom interfaces, data reports, and filters.

In certain of these embodiments, while the user may customize how certain data is displayed, certain essential data, such as patient allergies and a list of current medications, may not be removed from the display to maintain patient safety. In other words, certain embodiments of the system will limit certain types of customization that may negatively impact use of the interfaces displayed by the user device and overall patient care.

As mentioned above, the system of the present disclosure drives higher quality patient care at the point and time of patient care by providing better access to patient data, generating more usable information from that data, and directing or driving the physicians to make better decisions based on better structure of required physician inputs (or extraction of data) which leads to better access to overall total population health data.

To normalize the data, the system uses (or alternatively encourages users to select) data from one or more standard medical ontologies, such as those described by SNOMED-CT, ICD9 or ICD10, LOINC, RxNorm, CPT, etc. This data is then stored using the CCD C32 data structure as defined by the Healthcare Information Technology Standards Panel.

In further embodiments of the present disclosure, one or several apps or applications running on the user device and server include wrappers that use the user device's built-in web browser to display the interfaces. When the user logs into the system and specifies a host system, the application server matches the user data to a corresponding cascading style sheet (“CSS”) that defines the layout of the interface for that use. The application server then renders the interface on the user device using its built-in browser. For example, if the host system does not support computerized physician order entry (“CPOE”), then the user device would not display CPOE functionality to the user.

It should be appreciated that the apps or applications can also be exported into target builds specific to a user device or operating system, including for example, iOS, Android, Blackberry, and WebOS. These builds are “wrappers” configured to customize the user device browser and provide the user with the same experience as using a hard-coded application.

In certain embodiments, the interfaces are configured for the specifications of specific customers and users. This customization enables users to create a system that is not only intuitive, but also perfectly suited to their specific individual workflow, saving time, reducing errors, and increasing overall productivity and patient safety. The present disclosure further contemplates that alternative embodiments can add a Content Management System (“CMS”), accessible either within the application itself, or by a web page, which will enable users to modify their interfaces. With such a CMS in place, the system can be used to introduce new data capture modules or apps for quality reporting as well as feedback loops to incorporate additional decision support tools and functionality.

The present disclosure further contemplates that administrators and users will be able to redefine panes, windows, and interfaces to create customized access and input to the system and thus for sending to EMR and HIE systems. For example, using this system, two physicians accessing the same EMR or HIE system patient data or patient Encounters (defined below) could have different interfaces that are or have been customized for their specific specialties and/or workflows.

Although the interfaces discussed below are visual, it should be appreciated that the system also contemplates that in certain embodiments, data may be obtained from or entered into the system using audio such as voice commands.

### Implementation

The user device of the system of various embodiments of present disclosure is preferably a touch screen mobile or tablet computer or computing device such as: (i) the APPLE IPAD, (ii) the SAMSUNG GALAXY, (iii) the BLACKBERRY TAB, (iv) the HP TOUCHPAD, and (v) the MOTOROLA XOOM; however, it should be appreciated that other suitable user devices may be employed in accordance with the present disclosure. For example the user device may be a smart phone, a desktop personal computer, a wall mounted personal computer, a laptop computer, or a personal digital assistant. It should thus be appreciated that the user device may include one or more processors, one or more memory devices, one or more display devices, and one or more input devices, and will be able to communicate over one or more wired or wireless networks.

More specifically, it should be appreciated that: (i) the processor(s) of the user device can be any suitable type of processor(s) such as but not limited to one or more microprocessor(s) from the INTEL family of microprocessors; (ii) the memory or data storage device(s) of the user device can be any suitable type of memory or data storage device such as storage devices which include volatile memory and non-volatile memory such as but not limited to: random access memory (RAM), non-volatile RAM (NVRAM), magnetic RAM (MRAM), ferroelectric RAM (FeRAM), read only memory (ROM), flash memory, and/or EEPROM (electrically erasable programmable read only memory), other suitable magnetic memory devices, any optical memory device, or any semiconductor based memory devices); (iii) the memory or data storage device(s) can be configured in any suitable manner to store part or all of the program code and/or operating data for performing the functions described herein for the user device; (iv) the user device may also include a hard drive, CD drive, DVD drive, and/or other storage devices suitably connected to the processor(s) of the user device; (v) the memory or data storage device(s) store one or more software programs or applications executable by the processor(s) to enable the user device to perform the functions described herein; (f) the input device of the user device can be a touch screen or any other suitable type of input device besides a touch screen such as but not limited to: (a) a keyboard; (b) a mouse; (c) a track pad; (d) a track ball; and (e) a microphone which may be coupled to a voice recognizer; (vi) the display device(s) of the user device can be any suitable type of display devices such as but not limited to a conventional computer monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image; and (vii) the user device can include or be connectable by hard wire or wirelessly to one or more printers for printing any of the data displayed by the user device.

In various embodiments, the user device of the present disclosure will have one or more software applications (commonly referred to as “apps”) or computer programs of the system loaded on the server and on the user device to provide the user interfaces and functionality of the system of the present disclosure and to facilitate communication between the user device and the server of the system of the present disclosure. It should be appreciated that such applications or programs can be loaded or downloaded on the user device in any suitable manner. It should also be appreciated that the present disclosure includes the software applications or software programs on one or more memory or data storage devices separate from the user device or on the user device.

The present disclosure contemplates that the user device will display a plurality of different user interfaces to healthcare providers, enabling such healthcare providers to use the system to access patient records created and stored on a separate system, such as an EMR or HIE system. Two examples of these interfaces are described in more detail below. The various different interfaces will generally: (a) display patient data to the healthcare providers; and (b) enable the healthcare providers to input patient data during the daily routines of the providers. In some instances, the interfaces will be provided as pop-up windows that are displayed on top of other interfaces and in some instances the interfaces will be displayed in such a manner to completely replace the prior display or displayed window. It should be appreciated that the interfaces can be displayed in other suitable manners.

It should further be appreciated that the present disclosure contemplates that the present disclosure can also be implemented through one or more Internet web sites.

It should further be appreciated that the present disclosure contemplates that the servers of the system of the present disclosure will be any suitable servers, and can include “cloud” based hosting delivered by a third party.

It should further be appreciated that the present disclosure contemplates that the communication of patient data will be protected through suitable encryption that is compliant with HIPAA standards as defined by the Department of Health and Human Services of the United States government or other suitable regulatory body. It should thus be appreciated that all communication between any device and any server of the system is to be encrypted using standards that meet or exceed those defined by the HIPAA-HITECH Act. In various embodiments, this encryption will be performed using Secure Sockets Layer (“SSL”) or web services.

The present disclosure further contemplates that control of the functions or functionality of the user interfaces will be implemented by these applications or programs on the user devices, or that control of the functions or functionality of the user interfaces may be shared by the applications or programs on the user devices and by the server. In certain other embodiments, the user interfaces are more controlled by server. For example, the server may verify authorized access, may determine how the patient data is displayed, captured, and validated, and will be configured to broadcast patient data updates to the appropriate EMR systems and/or HIE systems.

It should further be appreciated that the user devices and server of the system may operate through any suitable wired, partially wired, or wireless data network. Thus, it should be appreciated that the system of the present disclosure can operate through any suitable central or remote network such as but not limited to a local area network (“LAN”), a wide area network (“WAN”), an intranet, and the Internet (such as through cloud computing). It should also be appreciated that the system will exchange data with other network devices via a connection to a data network. The network connections may be any suitable types of network connection, such as an Ethernet connection, digital subscriber line (“DSL”), telephone line, coaxial cable, etc.

By providing the user interfaces to the physician or other healthcare provider through a mobile device such as a touch screen tablet computing device, the present disclosure provides the physician or other healthcare provider with: (a) substantially increased access to stored patient data at the point of patient care (regardless of the physical location of the patient care) and at the time of patient care; and (b) increased ability to input new patient data quickly and easily at the point of patient care (regardless of the physical location of the patient care) and at the time of patient care. The user device of the present disclosure provides this patient data access and patient data input in a manner integrated into the normal daily routine of the physician or other healthcare provider as they care for patients and move from location to location in their offices, in hospitals, in other healthcare facilities, and in other locations of patient care.

It should be appreciated that while the various embodiments of the system of the present disclosure are described herein primarily in reference to one server and one user device, that any implementation of the system of the present disclosure will likely include more than one server, and likely include multiple user devices. For example, if a physician's office implements the system of the present disclosure, the office will likely have multiple user devices which enable the various healthcare providers in that physician's office to simultaneously use the system.

### Sample Workflow

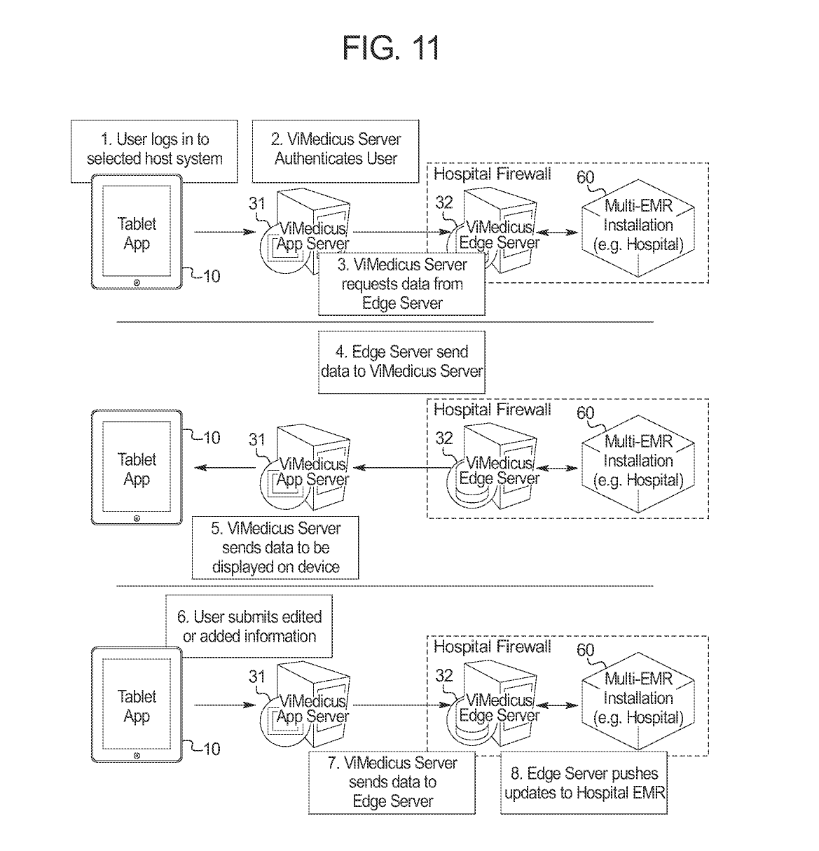

One example of how one embodiment of the system of the present disclosure (including the server and user device of the system of the present disclosure) communicates with existing EMR and HIE systems is generally illustrated in FIG. 11n this example embodiment, the system and particularly the user device 10 and the server 20 of the system are configured to be employed by and thus provide functionality for an outpatient primary care physician. In this example embodiment, the user device 10 is partially controlled by the server 20, which is the same server that operates the EMR system. It should be appreciated that the system and particularly the user device and server of the system can alternatively be configured for any specialty medical practices and for inpatient use. It should further be appreciated that each specialty medical practice is expected to require additional and/or different functionality in part because the daily routine of such other specialty medical practice physicians is substantially different than the daily routine of an outpatient primary care physician.

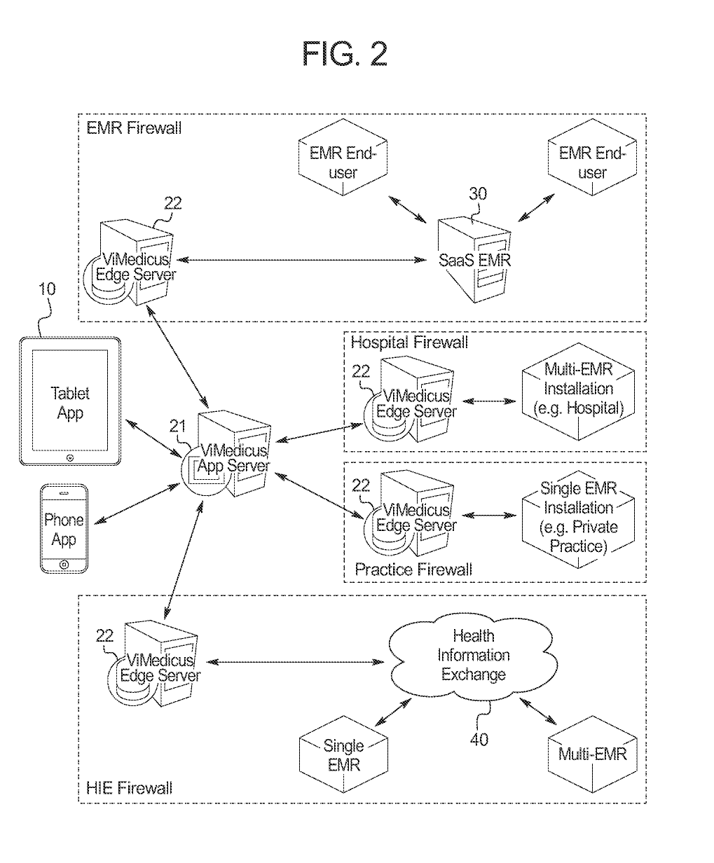

Another example workflow of this architecture is generally shown in FIG. 2. The healthcare system, generally shown in FIG. 2 as a multi-EMR hospital system, updates the patient record, mirrored from the host database on the Edge Server with any changes. The user device asks the user for login information. Once this information is inputted, the Application Server validates the user. The Application server will poll the Edge Server for the requested patient data upon user input. The Edge Server sends the requested information using standard, HIPAA-compliant encrypted HL7 and/or C32 messaging protocols. The Application Server sends the data as an SSL-encrypted XML message to the user device for display. The user device sends any new or edited data back to the Application Server. The Application Server sends the new data to the Edge Server. The Edge Server synchronizes with the hospital system. At the present time, certain known EMR systems provide multiple interfaces to access the same set of data (i.e., a client interface, a web interface, and a mobile interface). However, it should be appreciated that at the present time, no two different EMR systems share a common interface. The interfaces of the present disclosure provide a common interface for multiple different EMR systems.

It should also be appreciated that as mentioned above, commercial implementations of the present disclosure are expected, but not required, to include more than one user device. For example, the office of an outpatient primary care physician may have multiple user devices (such as at least one for each healthcare provider of the office) so that each healthcare provider in that office can simultaneously use the system of the present disclosure. The office may also include a single device shared by multiple users whose roles and access are differentiated through different user profiles and login credentials. It should also be appreciated that in certain instances the offices or these healthcare providers may already have one or more tablet computing devices (or other suitable computing devices as described above) without the application(s) of the system of the present disclosure, and that such tablet computing devices can function as the user devices described herein after such application(s) of the system are downloaded and installed on such devices.

More specifically, in this example embodiment, the user device 10 is configured to communicate with the system license validation server 20 of the system of the present disclosure for authentication or verification as further explained below. The user device 10 is also configured to communicate (after authentication or verification) directly with an EMR application server 30, which in this example is a commercially available ONC-certified web-based EMR system currently in use by physicians across the United States. In other words, the user device 10 communicates directly with the application server 30. The system thus achieves connectivity to or communication with various sources of patient data (i.e., various patient databases) through an application server such as the ezEMRx application server of an existing or legacy EMR system.

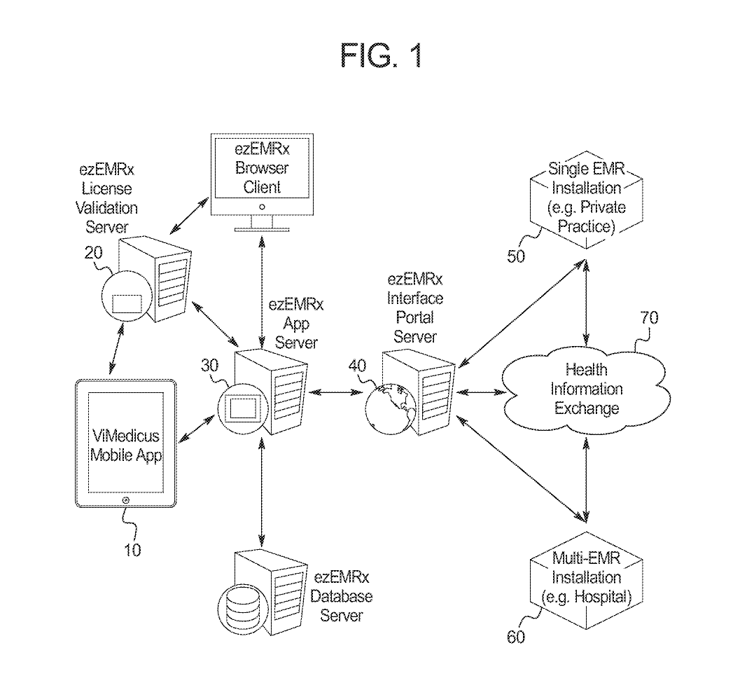

As shown in FIG. 1, the EMR system maintains an Interface Portal Server 40, which connects to other systems using standard HL7 or CCD protocols. For example, the Interface Portal Server 40 can connect directly to a single EMR system installation 50 provided the EMR system can communicate using CCD or HL7 standard protocols. In another example, the Interface Portal 40 can connect to an installation such as a hospital 60 using multiple EMR systems, provided the hospital can provide HL7 or CCD communication to each of its systems directly or through its own interface server. In another example, the Interface Portal Server 40 can connect to an HIE 70 through HL7 protocols, which can give the application server 30 access to read the data of systems connected to the HIE, such as single EMR systems 50 and multiple EMR systems 60. If the HIE 70 can provide write access to its contributing systems 50 and 60, the application server 10 can also write data to these systems by sending such data through the HIE. In this manner, the user device can read and write patient data to any EMR system that connects to the Interface Portal Server 40, either directly or indirectly (i.e., through an HIE). If a host system does not communicate via standard messaging protocols, then a set of application programming interfaces (or APIs) must be used. These APIs enable the direct communication of specific sets of patient information and must be provided by, or created with the vendors of the source EMR or HIE system.

In certain embodiments, the system requires the user device to be registered upon initial installation, but not thereafter (provided that the user device is password protected). In an example registration process, the user device 10 enables the user to input the Uniform Resource Locator (known as a “URL”) for the license validation server 20 of the system. The user device also enables the user to input user information such as the user's name, email address, phone number, as well as any optional comments. The user device 10 sends this information, along with the unique user device identifier, to the license validation server 20 to authenticate or verify the user device 10. The license validation server confirms that the user device is associated with an authorized user (such as a healthcare provider) through the unique identifier of the user device (such as the UDID for the APPLE IPAD). Upon authentication or verification, the license validation server 20 sends the URL of the application server 30 to the user device 10. The license validation server 20 also opens an encrypted session with the application server 30. This session periodically validates the user device 10 with the application server 30. If a license expires or is revoked, the application server 30 will cease service to the user device 10 in this example embodiment.

Upon completion of the registration process, in this example embodiment, the user device 10 is no longer required to communicate with the license validation server 20, and instead communicates directly to the application server 30.

### Sample Interface

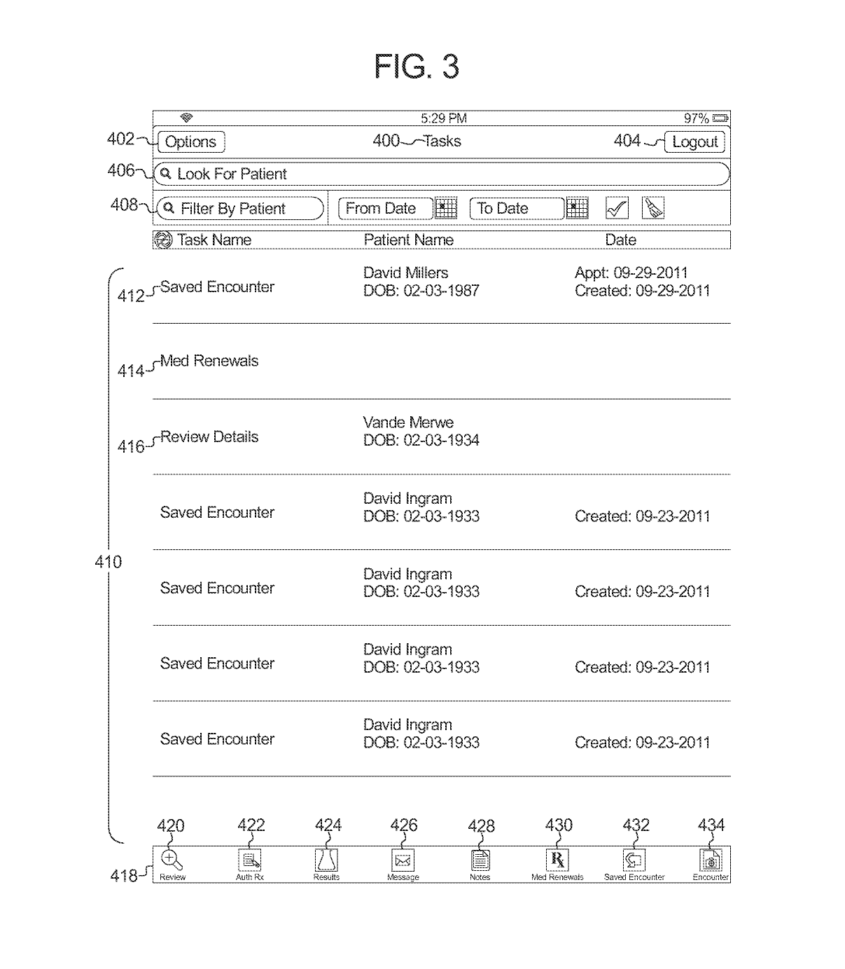

After initial registration, in this example embodiment, the system and particularly the user device enables the user to input their unique login name and their password using a login interface. The user device authenticates the user through the application server. In this example embodiment, the user device queries the server for a list of tasks in the user's task or to-do list stored on or by the system. The server returns the user's list of tasks to the user device and the user device displays the user's task list 410 in a Tasks interface such as the example Tasks interface 400 as generally shown in FIG. 3 and discussed in further detail below. In this example embodiment of the present disclosure, the user Task interface is one of the fundamental navigational elements for the users—when the “home” button is used, it returns users to this screen.

It should be appreciated that in alternate embodiments, the system administrator or user may configure a different set of initial reports or notifications or apps to populate their “home” or starting interface. The list of tasks shown in FIG. 3 is a list of task for the user for that day which is a default setting because that is how physicians generally practice. It should further be appreciated that the system can display the user's list of tasks or task list for other desired time periods such as but not limited to an hour, a four hour period, an eight our period, a week, a month, or a year. In various embodiments, the user can set this period of time for the task lists. The Task interface is one of the interfaces that the physician is expected to return to multiple times throughout the day, and to guide the physician as they go about their day. An alternative “home” screen could be a practice-wide patient dashboard, indicating the overall health of a provider's patient population, with notifications for at-risk patients or emergent test results. Another “home” screen could be a practice's financial “health” dashboard, indicating outstanding debts from patients or payers as well as practice quality performance indicators toward reimbursement goals (such as number or percentage of e-prescriptions).

The top of the Task interface 400 includes or displays an Options selection 402, which when activated, enables the physician to perform certain system related functions such as changing the physician's password. It should be appreciated that other suitable system related functions may be implemented as options for the user such as setting the period of time of the task list.

The top of the Task interface 400 includes or displays a Logout selection 404, which when activated, enables the physician to logout of the system.

The top of the Task interface 400 also includes or displays a Look for Patient List text field 406 that enables the physician to locate patient data on EMRs for a specific patient (whether or not a task for that patient is present on the physician's task list) by conducting a search for that specific patient data by typing in the patient's name. When the physician inputs a patient name in the Patient List text field 400, the user device initiates a search for patients that match the input typed into that search field. The user device queries the server for a list of names for all patients associated with the logged-in user that match the inputted character(s). The server returns the list to the user device and the user device displays that list. Once any of the listed patients are selected from the displayed list by the physician, the user device requests and obtains the full patient record from the server, and then displays a Patient Overview interface for that specified patient. This Patient Dashboard interface is another interface that the user will often use when reviewing the records of and when seeing or treating a specific patient. This interface and the various interfaces, which are readily accessible from the interface for a specific patient, are further discussed below. These interfaces also readily enable multiple different treating physicians to view the specific patient data and to see what patient data other physicians have entered as further discussed below.

Turning now back to FIG. 3, the top of the Task interface 400 further includes or displays a Filter by Patient text field 408 and related date fields that enable a physician to search tasks by patient name or date.

The middle of the Task interface 400 includes or displays a list of the physician's tasks for that day as further discussed below. When the physician selects one of these listed tasks, the user device operates with the server to open the appropriate interface which enables the physician to work on or complete the selected task. In this example, the user device displays the individual tasks 410 in the Tasks interface 400 chronologically, with newest items or tasks displayed first as generally shown in FIG. 3. These tasks can be displayed in order of importance or in order of time periods or appointments during the day. It should be appreciated that although the appointment times are not shown on the example task list in FIG. 3, that the tasks list can include appointment times and a well as other information desired by the user. It should further be appreciated that the tasks may be displayed in other suitable manners as also discussed below.

It should be appreciated in this example that: (a) each interaction with a patient is referred to herein as a Patient Encounter or an Encounter; and (b) a Saved or Draft Encounter is a partially completed patient encounter record that has not yet been submitted and that may be edited by an authorized user. It is expected that a Saved or Draft Encounter may be partially completed by a healthcare provider or a support staff member in the physician's office before the physician sees the patient. It should be appreciated that a Draft Encounter for a patient may be initially created when an appointment for a patient is scheduled. Prior to the appointment, patient data can be added to or linked to the Saved or Draft Encounter. When the physician actually sees the patient, the physician can review information in the Saved or Draft Encounter (as well as access other patient data as discussed below) will input further patient data about the patient. During or after seeing the patient, the physician or another user can finalize the Saved or Draft Encounter with this additional patient data. In this example embodiment, the user device sends both Saved or Draft Encounters and Submitted Encounters to the server to be saved, but the server does not send the Saved or Draft Encounters to EMR or HIE systems until they have been finalized as Submitted Encounters. It should also be appreciated that an Encounter does not have to have every possible patient data field filled out to be considered finalized. In certain embodiments, various designated fields of an Encounter do need to be filled out for the Encounter to be considered finalized.

It should also be appreciated that the system of the present disclosure also enables a physician or other user to create Encounters for patient encounters which occur over the telephone such as a late night call with a patient. This enables the physician to easily document the telephone patient encounter and if appropriate obtain payment for such encounter. It should thus be appreciated that the system of the present disclosure provides a tool for the users to create Encounters or EMRs when the users are not in a normal patient treating environment such as a physician's office or hospital.

When a Draft Encounter selection such as Saved or Draft Encounter selection 412 is activated, the user device displays an Encounter interface. An example Encounter interface enables the physician or user to perform many different tasks such as record, code, and submit data regarding a patient examination. Similarly, when an Encounter selection is activated, the user device displays the same Encounter interface, which enables the physician or user to open a New Encounter and thus start to create a new Encounter. It should be appreciated that the user device enables the physician to access these interfaces through multiple different paths such as: (i) a scheduled New Encounter from the Task interface; (ii) a Saved or Draft Encounter from the Task interface, or (iii) a New Encounter from the Encounter tab of the Patient Dashboard interface (which is described in detail below). The Encounter interface of the present disclosure provides a structured workflow including various tabbed elements as further discussed below. It should thus be appreciated that one way the system of the present disclosure organizes patient data is around patient encounters which is the way healthcare providers interact with patients (i.e., patient encounter by patient encounter).

In the example task list of FIG. 3, the user device displays a Saved or Draft Encounter selection 412 for an example patient David Millers that the physician needs to complete and submit. As mentioned above, when this Saved or Draft Encounter selection 412 is activated, the user device will display the specific Patient Encounter for example patient David Millers to further enable the physician to review that specific patient's data and update the patient's data as further discussed below. This can include viewing and changing one or more of the areas of the patient's medical records, such as allergies, medications, and immunizations as further discussed below.

In this example, the Review Details tasks 416 (for example patient Vande Merwe), when activated, causes the user device to display the Encounter interface for example patient Vande Merwe. Thus, it should be appreciated that the user device enables the physician to access this Encounter interface for example patient Vande Merwe in multiple different ways.

It should also be appreciated that the physician's task list (such as the Task list shown in FIG. 3) is expected to be a changing task list during the day that is easy for the physician to view as the physician accomplishes tasks and as new tasks are added to the physician list by the physician, the other users in the physician's office, or other healthcare providers such as other physicians treating the same patients as the physician (which provides a collaborative approach between treating physicians). For this third point, the tasks list enables a physician to easily contact or send a message to another physician, and to see a message from another physician and to easily respond thereto, thereby creating a move collaborate environment. In other words, the system and specifically the task list facilitate communication between busy physicians. The system also will reduce the number of faxes which are sent to physicians (as described above) because the faxed documents can be attached to the messages between physicians, or the information in these previously faxed documents can simply be accessed from the message interfaces accessed by the receiving physician as described below. Additionally, the system will enable multiple different care providers to access the same information previously contained in these faxes through the interface provided by the user device of the present disclosure.

This example Task interface 400 enables the physician to complete certain of the tasks in their task list while they are actually with or seeing patients, thus eliminating or reducing the need for the physician to spend time creating or updating records after they see each patient or at the end of the day. For example, while visiting with a patient, the physician can access and edit that patient's records (or Saved or Draft Encounter and saved previous Encounters) while speaking with the patient without turning the physician's back on the patient or looking over a computer screen or desk at the patient. At the same time, the physician can use the user device to renew the patient's prescriptions as further described below. If the patient needs to move to another room for a test or procedure, the physician can take the user device with them and continue to take and input notes that are stored in the Encounter and then eventually sent directly into an EMR and/or HIE system. The Task interface 400 enables the physician to complete certain of the tasks in their task list for other patients (not being seen) between seeing patients during their day. For example, between seeing two patients, the Task Interface enables the physician to confirm a medication renewal for a patient (not being seen that day by the physician). In another example, between seeing two patients, the Task Interface enables the physician to communicate with another physician for a patient (being seen or not being seen that day by the physician). This makes the physician's day more efficient and integrates most or many of the physician's required tasks for the day into one device (even as those tasks change minute by minute and hour by hour). It should be appreciated from this that the entry of patient data and the access to patient data is based on the daily tasks that the physician must perform. In one sense, the tasks list is a guide for the physician as the physician goes about their day seeing patients and performing other patient related activities or tasks and is an integrated part of their day.

More specifically, in the example task list 410 shown in FIG. 3, the physician has a list of selectable tasks including: Saved or Draft Encounter 412, Med Renewal 414, Review Details 416, and a series of additional Save Encounters (which are not numbered). Additional selectable tasks which will likely be in the typical task list and which are described below and shown in other figures include: Authorize Rx, Results, Incoming Message, and Incoming Notes. It should be appreciated that the system may include any suitable different types of tasks and preferably includes all of the patient related tasks or all of the significant patient related tasks that the physician must perform during the day. In this example for the outpatient primary care physician, the general possible tasks includes enabling the physician to: (i) review changes in patient details (e.g., a new allergy); (ii) input data about a patient; (iii) authorize a prescription for a patient; (iv) renew a prescription for a patient; (v) review incoming patient lab results; (vi) review incoming messages sent from another physician or other user within the physician's practice or from a third party regarding a patient; and (vii) view and edit a previously saved patient encounter. More detailed descriptions of certain of these example tasks are provided below. After the physician addresses and completes work on each task for a patient, the user device will enable the physician to keep that Task selection in this Tasks list or to remove this Task selection from the list because the physician no longer needs to address it.

The bottom of the example Task interface 400 includes or displays a toolbar 418 containing the following: (i) a Review selection 420, which, when activated, enables the physician to mark the task as “reviewed” and removes the item from the list of tasks; (ii) a Prescription Authorization selection 422 selection, which when activated enables the physician to see a filtered list of active tasks that only displays Prescription Authorization tasks; (iii) a Results selection 424, which, when activated, enables the physician to see lab or test results for a patient; (iv) a Message selection 426, which, when activated, enables a physician to see a filtered list of active tasks that only displays Incoming Messages; (v) an Incoming Notes selection 428, which, when activated, enables the physician to see a filtered list of active tasks that only displays Incoming Notes; (vi) a Medication Renewal selection 430, which, when activated, enables the physician to see a filtered list of active tasks that only displays Medication Renewal tasks; (vii) a Saved or Draft Encounter selection 432, which, when activated, enables a physician to see a filtered list of active tasks that only displays Saved or Draft Encounters as described below; and (viii) an Encounter selection 434, which, when activated, enables a physician to see a filtered list of active tasks that only displays a list of scheduled Encounters for patients as described below.

In an example task list, the user device displays a list of Review Details selections for different patients, which, when activated, each causes the user device to display the Review Details Task Interface for the specific referenced patient. After the physician addresses and completes work on a Review Details selection for a patient, the user device will enable the physician to keep that Review Details selection in this list or to remove this Review Details election from the list because the physician no longer needs to address it. In another example task list, the user device displays a list of Incoming Notes selections, which, when activated, causes the user device to display the Incoming Notes Task Interface. It should be appreciated that this list is expected to often have multiple Incoming Notes selections for multiple different patients and/or for the same patient. After the physician addresses and completes work on an Incoming Notes selection for a patient, the user device will enable the physician to keep that Incoming Notes selection in this list or to remove this Incoming Notes selection from the list because the physician no longer needs to address it. This provides an easy tool for collaboration between multiple treating physicians.

In yet another example task list, the user device displays a list of New Message selections, which, when activated, causes the user device to display the Messaging Interface. The Messaging Interface enables the user to reply to messages. It should be appreciated that this list is expected to often have multiple New Message selections for multiple different patients and/or for the same patient. After the physician addresses and completes work on a New Message selection for a patient, the user device will enable the physician to keep that New Message selection in this list or to remove this New Message selection from the list because the physician no longer needs to address it. This also provides an easy tool for collaboration between multiple treating physicians.

In an example task list, the user device displays a list of Medication Renewal selections for the same example patient, which displays a list of individual incoming patient medication renewals each of which requires attention by the physician. When the physician selects or activates one of the renewals, the user device displays a specific Patient Rx Renewal interface, which is described below. It should be appreciated that this list is expected to often have multiple Medication Renewal selections for multiple different patients. After the physician addresses and completes work on a Mediation Renewal selection for a patient, the user device will enable the physician to keep that Medication Renewal selection in this list or to remove this Medication Renewal selection from the list because the physician no longer needs to address it. It should also be appreciated that the organization or incorporation of all the these additional tasks (besides seeing patients) into the physician's daily patient visitation schedule will make the physician more efficient and will also enable to physician to complete these tasks whenever the physician has down time during the day rather than at the beginning or end of the physician's day, or during meal time.

In an example task list, the user device displays a list of Saved or Draft Encounters selections for multiple example patients, which, when activated, causes the user device to display an Encounter Interface. After the physician addresses and completes work on a Saved or Draft Encounter selection for a patient, the user device will enable the physician to keep that Saved or Draft Encounter selection in this list or to remove this Saved or Draft Encounter selection from the list because the physician no longer needs to address it such as because the encounter has been completed and the Saved or Draft Encounter has been finalized into an Encounter and sent by the system to an EMR or HIE system.

In an example task list, the user device displays a list of Encounters selections, which, when activated, causes the user device to display the Encounter Interface. After the physician addresses and completes work on an Encounter selection for a patient, the user device will enable the physician to keep that Encounter selection in this list or to remove this Encounter selection from the list because the physician no longer needs to address.

For each patient, Encounter, or Saved or Draft Encounter, the user device also provides an Authorize Prescriptions selection, which, when activated, causes the user device to display a Prescription Authorization interface. The Prescription Authorization interface enables the physician (assuming the physician has a valid DEA number) to authorize a medication inputted by another healthcare provider within their practice. The Prescription Authorization Interface includes or displays a prescription interface which is described below. The bottom of the Prescription Authorization Interface includes or displays a toolbar containing the following selections: (i) an Add selection, which, when activated, enables the physician to add the prescription to the list of active medications; (ii) a Reset selection, which, when activated, resets all of the interface fields; (iii) a Prescribe selection, which, when activated, enables the physician to prescribe the medication; (iv) a Void Prescription selection, which, when activated, enables a physician to void the prescription; and (v) a Pharmacy Search selection, which, when activated, enables the physician to search for a pharmacy.

The Medication Renewal Interface includes or displays a Medication Renewal Details interface, which contains details for the following: (i) Received Patient Details interface, which displays the patient details as received from the pharmacy requesting a renewal; (ii) ezEMRx Patient Details, which displays the patient details as stored in an EMR system; (iii) Pharmacy Details, which displays the details of the pharmacy requesting the renewal; and (iv) Medication Details, which displays the details of the prescription to be renewed. The bottom of this example Prescription Authorization Interface includes or displays a toolbar containing the following: (i) a Renewal Request Details selection, which, when activated, causes the user device to display the Renewal Request Details interface; (ii) an Allergies selection, which, when activated, causes the user device to display a patient allergy interface; (iii) a Medications selection, which, when activated, causes the user device to display a patient medication interface; and (iv) a Medications selection, which, when activated, causes the user device to display a patient problems interface.

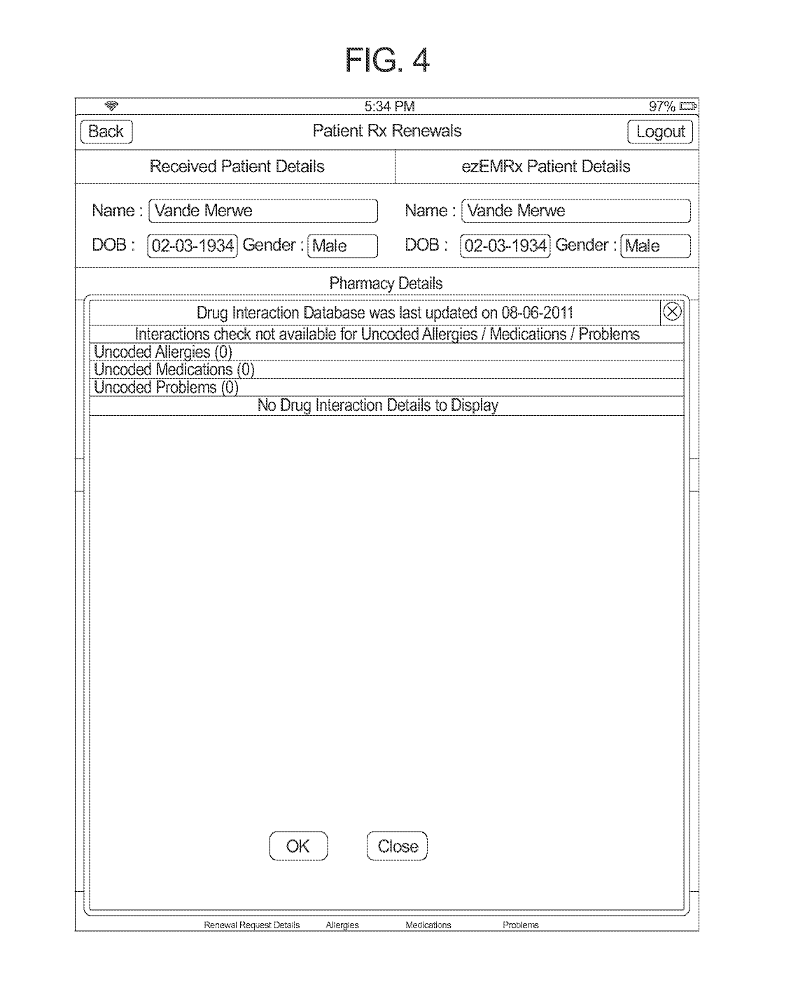

Upon acceptance of the renewal request, the system runs a drug interaction check and notifies the user of the results, as shown in FIG. 4. This immediately provides valuable information to the physician regarding possible adverse medication interactions while the physician is thinking about the patient and the best course of treatment for the patient. This enables the physician to alter the course of treatment or medication if an adverse medication interaction message or information is returned to the physician. As the number of physicians that use the system for patients increases, the likelihood that all of a patient's mediations will be in the system increases, and thus this no adverse medication interaction will become more accurate. It should also be appreciated that the system can be configured to access one or more third party medication databases to obtain information on medications, and in certain embodiments, such data bases can be embedded as an app or as an application accessible through the system.

In this embodiment, all physicians are a part of the same practice and have access to the same information. It should be appreciated that in certain embodiments, the system of the present disclosure can indicate whether all of a patient's treating physicians are using the system, as well as what aspects of the patient record are visible to them. For example, if a physician's system is unable to accept and/or transmit complete patient medication records due to non-compliance with HL7 or CCD standards, the system can display to other users which medications are not being communicated properly. This enables patients (using the patient portal) and other providers to be aware of what medication information is not being properly communicated.

It should further be appreciated that various additional advantages of the system of the present disclosure is the facilitation of cross verification of medications taken by patients. More specifically, different physicians often prescribed different medications for a single patient. When each physician prescribes a medication for a patient, the system will store (at an appropriate EMR or HIE system) all of the relevant data regarding that prescribed medication for that patient such that each other physician that uses the system of the present disclosure will be able to view all of the previous prescribed medications for that patient. This will provide each physician better and more accurate data about previous care and treatment for the patient.

Additionally, when each physician sees a patient (i.e., at an encounter), the physician or the physician's assistant will typically ask the patient (orally or in writing) what medications the patient takes. When the physician or physician's assistant enters this data into the system using the user device, the system can immediately verify this data and report back any inconsistencies to the physician, and additionally can send messages (i.e., Incoming Messages) to the other physicians that treat that patient as to any inconsistencies. This can for instance provide a notice or Incoming Message to another physician that has previously treated the patient and prescribed medication for the patient, that the patient is at this encounter is not saying they are taking such prescribed medication. This enables the second physician to act on this Incoming Message such as by contacting the patient to discuss why the patient is not taking the prescribed medication.

In one embodiment, the Encounter interface includes or displays a Vitals selection, which, when activated, causes the user device to enable the physician to input data such as text and/or numerals relating to any of the patient's vitals taken during an encounter, including but not limited to: (i) Height, (ii) Weight, (iii) Blood Pressure, (iv) Respiratory Rate, (v) Oxygen Saturation (SaO2), (vi) Pulse, (vii) Peak Expiratory Flow Rate (PEFR), and (viii) Temperature. It should be appreciated that other suitable additional fields for patient vitals may be included such as for a pediatric patient head and mid-arm circumference.

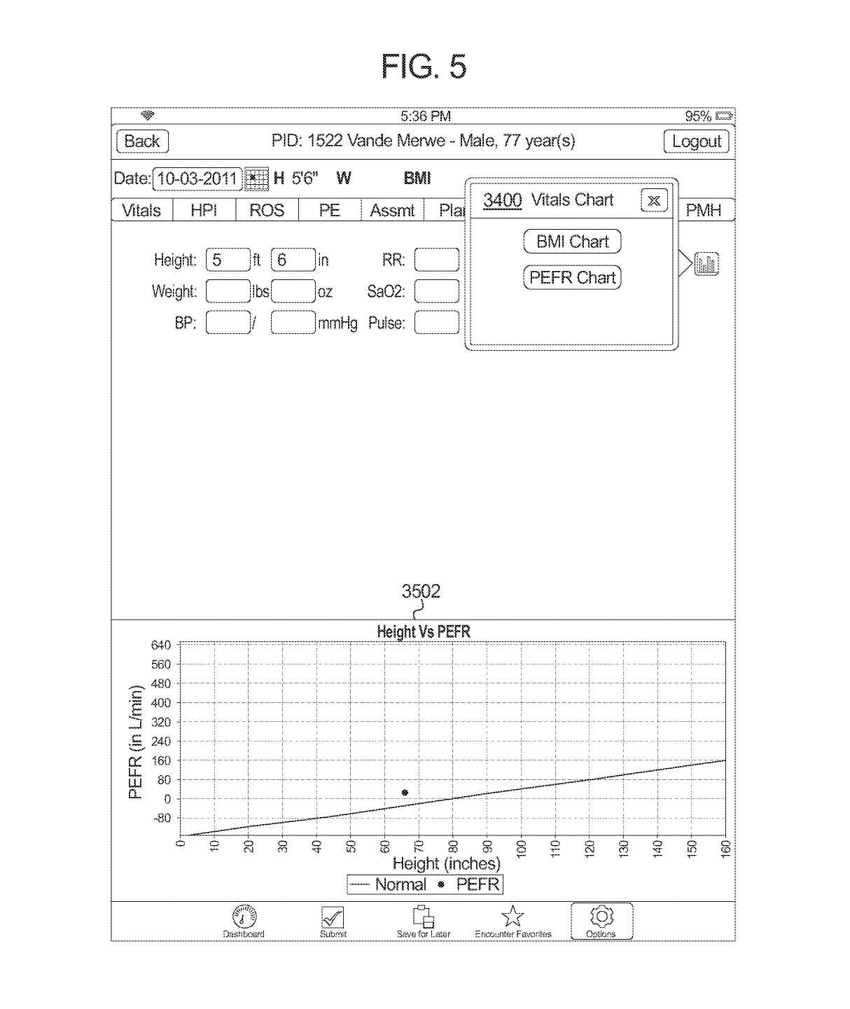

The Encounter interface also includes or displays a Chart selection, which, when activated, causes the user device to display an interface that enables the user to view a graph of the patient's Body Mass Index and Peak Expiratory Flow Rate. An example of this chart display is shown in FIG. 5.

In an embodiment, the Encounter interface also includes a selection which enables the user to schedule a follow-up appointment for the patient. It should be appreciated that when this appointment is scheduled, the system can automatically create a Saved or Draft Encounter for that patient for that scheduled appointment.

In one embodiment, the Encounter interface includes an Encounter Favorites selection, which, when activated, causes the user device to display a list of “favorites,” or templates for Encounters which, when selected, will automatically fill one or more of the fields throughout the Encounter interface, enabling the user to save time entering data for common encounter scenarios. For example, if a physician is seeing a large number of patients exhibiting similar symptoms (such as the flu or common cold), he or she may record a template that pre-fills fields with these common symptoms and customize them during the patient encounter with any necessary changes. If the host system is able to export template data, the templates can be built using the host system and imported to the present system. In alternate embodiments of the present system, the user will be able to create templates using the system's interface.

In an embodiment, the Encounter interface includes or displays a History of Present Illness (“HPI”) selection. The HPI selection, when activated, causes the user device to display an HPI Interface which includes two text fields including one for the Chief Complaint and one for the History of Present Illness. The user device also provides a selection option which enables the physician to select from a list of favorites, which will then populate the fields with previously saved data.

In one embodiment, the Encounter interface includes or displays a Review of Systems (“ROS”) selection. The ROS selection, when activated, causes the user device to display a ROS interface that includes a text field for the Review of Systems. The user device also provides a selection option which enables the physician to select from a list of favorites, which will then populate the field with previously saved data.

One embodiment of the Encounter interface includes or displays a Physical Exam (“PE”) selection. The PE selection, when activated causes the user device to display a PE interface which includes a text field for the Physical Exam. The user device also provides a selection option which enables the physician to select from a list of favorites, which will populate the field with previously saved data.

In one embodiment, the Encounter interface includes or displays an Assessment selection. The Assessment (“Assmt”) selection, when activated, causes the user device to display an Assessment interface having two searchable fields. The user device enables the user to search either by ICD-9 or, eventually, ICD-10 Problem Code or by Problem Name. The user device enables the user to input one or more characters into any field and then touch the search icon (represented as a magnifying glass). The user device sends the search criteria to the application server to search against a data dictionary of ICD-9 or ICD-10 codes and names. The application server returns a list of matching items to the user device and the user device displays this list in a drop-down menu beneath the search field. One or more problems may be found and added to the Assessment through the use of these fields. The Assessment interface also provides a text field for the additional notes. The user device also provides an option to select from a list of favorites, which will populate the fields with previously saved data.

In one embodiment, the Encounter interface includes or displays a Plan selection. The Plan selection, when activated causes the user device to display a Plan interface which includes a Plan text field, a Prescriptions and Investigations text field, and an Assessments text field for previously inputted data selection. The user device also displays an option to select from a list of favorites that will populate the Plan text field with previously saved data.

One embodiment of the Encounter interface includes or displays a Coding selection. The Coding selection, when activated causes the user device to display a Coding interface which enables the user to Code the patient encounter. This Coding interface enables the user to search within fields to input E&M, CPT, and ICD Codes, Descriptions, and Modifiers. This Coding interface displays two search fields that enable the physician to type one or more characters into either field and then touch the search icon (represented as a magnifying glass). The user device sends the search criteria to the application server to search against data dictionaries for the various codes and names. The user device also displays a selection option which enables the physician to select from a list of favorites, which will populate the Coding fields with previously saved data.

In one embodiment, the Encounter interface also includes or displays a Social History (“SH”) selection. The Social History selection, when activated, causes the user device to display a Social History interface, which provides access to the following sub-tabs: Summary, Smoking, Alcohol, Caffeine, Exercise, General, Substance Abuse, Sexual Exposure, Environmental Assessment, and Other. These tabs each contain lists for the user to check as well as a text field for additional notes to update to the patient's social history.

In an embodiment, the Encounter interface further includes or displays a Family History (“FH”) selection. The Family History selection, when activated causes the user device to display a Family History interface which enables the physician to select from a list of common diseases or input a new disease, to select a family member with whom the disease is associated, and to add this data to the patient's family history.

The Encounter interface further includes or displays a Past Medical History (“PMH”) selection. The Social History selection, when activated causes the user device to display a Social History interface which enables the physician to access the following sub-selections: (i) Summary, (ii) Medication History, (iii) Hospitalization, (iv) Surgical History, (vi) History of Trauma, (vii) Immunization, (viii) Screening, (ix) Problem, and (x) Dental History. These sub-selections, when activated, each display interfaces which includes one or more fields which enable the physician to add events to the patient's past medical history. The summary of the past medical history changes is shown in the Summary sub-selection.

In one embodiment, the Encounter interface further includes or displays a Dashboard selection. The Dashboard selection, when activated, causes the user device to display an Overview interface or Patient Dashboard interface which displays a summarized view of the patient data and which enables the physician to easily and quickly access various data about the patient. The Patient Dashboard interface or Overview interface. This Overview interface includes or displays: (a) the patients name, gender, and age at a section of the top of the interface; (b) the patient's most recent set of vitals at a section of the top of the interface; (c) the patient's known allergies at the top of the interface; (d) the patient's current medication at the top of the interface; (e) a series of scrollable rows (or sets) of user selections that enable the physician to access the patient's lab results, the patient's chronic problems, and recent encounter notes in the middle of the interface.

More specifically, this Overview includes or displays the patient's lab results as a scrollable series of selections, each of which displays the type of lab test and the date the results were received. When the physician activates one of these selections, the user device displays the full results from the selected test. The user device includes a selection which, when activated, causes the user device to display a Graph selection that enables the physician to select one or more of the individual results and view a graph of the data over time to determine trends.

This Overview interface also displays the patient's chronic problems as a scrollable series of selections, each of which displays the type of problem and the onset date. When the physician activates one of these selections, the user device displays a description of the problem, the onset and resolution date (if applicable) as well as any comments.

This Overview interface also displays the patient's list of encounters as a scrollable series of selections, each of which display the chief complaint, the physician who recorded the encounter, and the date of the encounter. When the physician activates one of these selections, the user device displays the full text of the encounter.

The Patient Dashboard interface also has a row of user selection which include: (i) an Overview selection; (ii) an Allergies selection; (iii) a Meds selection; (iv) a Vitals selection; (v) a Labs selection; (vi) a Demo selection; (vii) a Problems selection; (viii) a Screen or Scrn selection; (ix) an Immunization or 1 mm selection; and (x) an Encounter or Enc selection.

More specifically, the Overview selection of the Patient Dashboard interface, when activated by the physician, causes the user device to display the Overview interface. This enables the physician to easily and quickly return to this default or base interface when the user device is displaying another interface accessed from the Patient Dashboard interface.

The Allergies selection of the Patient Dashboard interface, when activated by the physician, causes the user device to display a list of the patient's current allergies. The user device displays an edit icon (represented as a pencil) next to each listed allergy, which when selected by the physician opens an interface, which has a series of fields and drop-downs that enable the physician to input various allergy related data including details of the associated allergy. The text field for the allergen, labeled Allergic To, has a search icon, which enables the user to type one or more characters and search a data dictionary of known allergens, and to select one of the displayed known allergens. The Severity field has an associated drop down menu for Severity, which can be set by the physician as mild, moderate, or severe. The Status field has an associated drop down menu for Status, which can be set by the physician to be set as active, inactive, or erroneous. The Event field has an associated a drop down menu which can be set by the physician to one of the following: (a) propensity to adverse reactions, (b) propensity to adverse reactions to substance, (c) propensity to adverse reactions to drug, propensity to adverse reactions to food, and (d) allergy to substance, drug allergy, food allergy, drug intolerance, or food intolerance. The Adverse Event Date text field, when activated opens a date selection tool that enables the physician to record adverse event dates. The Reaction free text field enables the physician to input and thus document any further comments on the patient's allergy. It should be appreciated from this specific example that the user device: (a) enables the physician to easily input pertinent data while the physician is seeing the patient without requiring additional data entry time during the time the physician is seeing the patient or thereafter; (b) that this interface replaces the need for the physician to write down this data while seeing the patient or thereafter; and (c) this interface also implicitly reminds the physician of all the patient data which the physician should obtain from the patient.

In a further embodiment, the Patient Allergies interface includes an Add selection, that when selected, causes the user device to display an Add Allergy interface which provides the same options as the Edit selection and that enables the physician to input data regarding a new patient allergy. In this example, the Adverse Event Date is initially set to the date of entry.

The Medication (“Meds”) selection of the Patient Dashboard interface, when selected, causes the user device to display a Medication Prescription interface. The Medication Prescription interface includes or displays Generic Name 6604 and Medication text fields which enable the physician to search for a medication the physician wants to prescribe to the patient by generic medication name or the actual medication name. When the physician starts to type in the Generic Name field, the user device displays suggestions from the data dictionary in a drop down menu below the field as the user types. The physician may leave the Generic Name field empty. When a generic name is selected, the user device prompts the physician to select a specific medication from the Medication field. The user device displays suggestions from the data dictionary appear as a drop down menu below the field. If the physician selects the Medication field, the user devices displays suggestions from the data dictionary appear as a drop down menu below the field as the physician types. After the physician chooses a specific medication, either by generic name or medication name, the user device prompts the user to input a dosage form. The user device displays various options for the physician in a drop down menu below the Dosage Form field. The dosage options are specific to the chosen medication. After the dosage form is inputted, the user device prompts the physician to input the strength. These options are presented in a drop down menu below the Strength field. These strength options are also specific to the chosen medication. After the strength is inputted, the user device prompts the physician to input the dispense form. These options are presented in a drop down menu below the Dispense Form field. These options are also specific to the chosen drug or medication. The user device enables the physician to input the quantity into the Quantity text field. The user device enables the physician to input the duration into the Duration text field. The user device also easily enable the physician to select one of the radial selection next to “Days,” “Months,” or “Years” to select the duration. The user device also provides a drop-down menu to enable the physician to select a Qualifier, if applicable. The Medication Prescription interface further includes a free form text field for the sig. Alternatively, the user device enables the physician to select items from four drop-down menus: (i) “Sig Selection 1” enables the physician to choose a number or number range; (ii) “Sig Selection 2” enables the physician to choose a dispense form; (iii) “Sig Selection 3” enables the physician to choose an instruction (e.g., “by mouth”) and (iv) “Sig Selection 4” enables the physician to select the frequency (e.g., “daily”).

The user device enables the user to check the Dispense as Written (“DAW”) checkbox or select a number and check the Pro Re Nata (“PRN”) box. The user device also enables the physician to check whether a medication substitution is allowed. The user device enables the physician to check a box to “Apply Medication to long-term care” which notifies the pharmacy filling the prescription that the medication is meant for long-term care.

In one embodiment, the bottom of the Medication Prescription interface includes or displays: (i) an Add selection which enables the physician to add the medication to the list of medications to be prescribed; (ii) a Reset selection which resets all of the text fields and drop-down menus (upon activation of a confirm selection); (iii) a Prescribe selection which enables the physician to prescribes any medications added (requires an active DEA number associated with the user account); (iv) a Prescription Favorites (or “Rx Fav”) selection which enables the physician to add the prescription to a list of favorites for faster subsequent entry by the physician; (v) a Pharmacy Search selection which opens an interface which enables the physician to search for and select a pharmacy by city, zip code or pharmacy name; and (vi) a Prescription History (or “Rx History”) which displays a history of prescriptions made by the user for the selected patient.

In one embodiment, the Medication Prescription interface further includes or displays an Active selection, that, when selected, causes the user device to display a Medication interface, which enables the physician to see a list of the active or current medications for the patient (i.e., the medications that the patient is suppose to be taking). The user device enables the physician to select the Add selection to add medication to the list of active medications for the selected patient. When this Add selection is activated, the user device displays an interface which has substantially the same menu options as the Prescription interface, and includes the additional option which enables the physician to input a start date and an end date for the patient to take the medication. The user device further enables the physician to select any one of the active medications and edit the associated data for that medication using the Update selection (represented as a pencil). When this Update selection is activated, the user device displays an interface, which has substantially the same menu options as the Add medication interface.

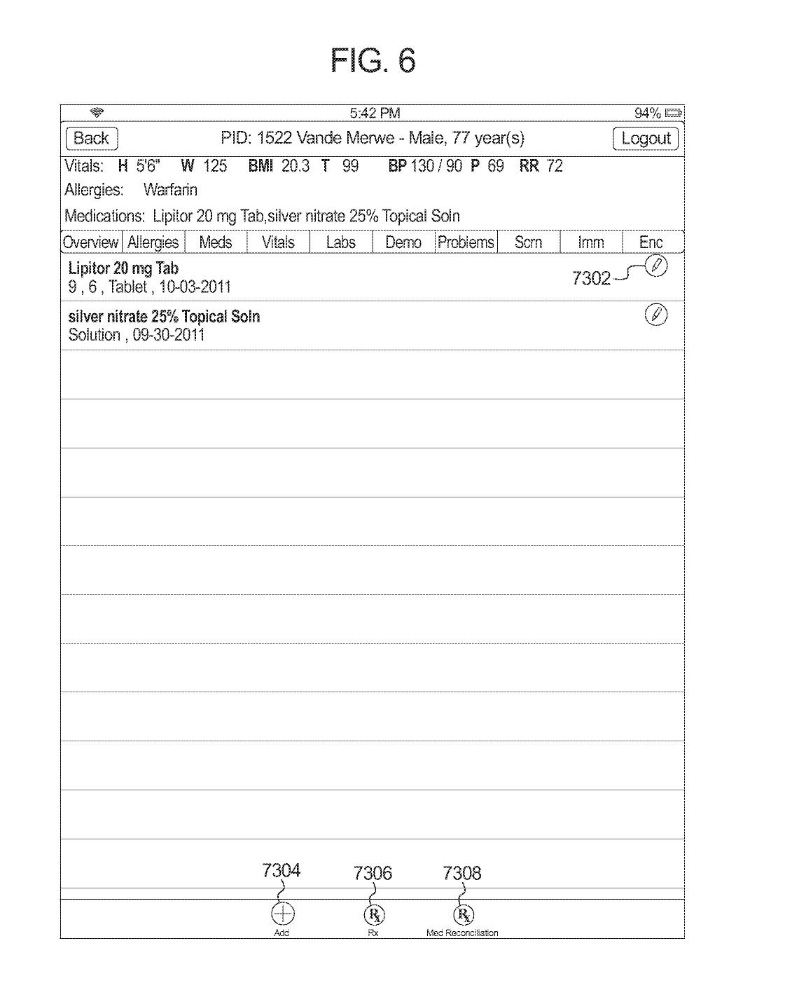

The Medication interface further includes or displays an Rx selection 7306 as shown in FIG. 6 that enables the physician to return to the Prescription interface.

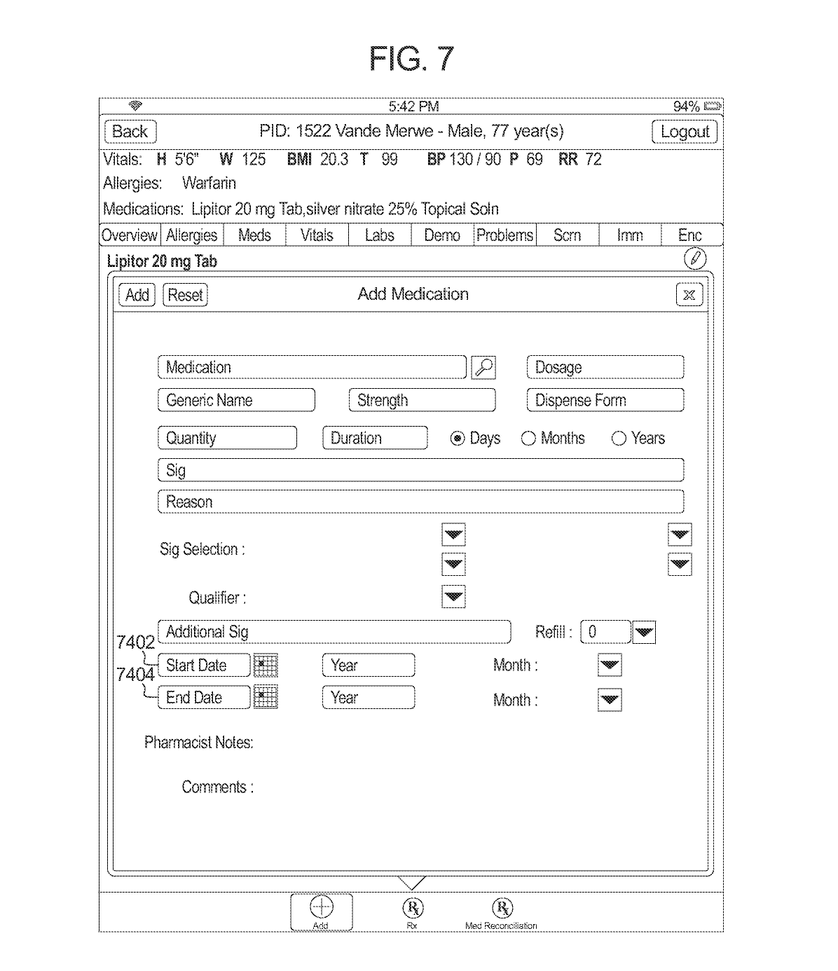

In one embodiment, the Medication interface includes or displays an Add Medication selection 7304, which when selected displays an Add Medication interface to enable a physician to add a medication to the patient's prescription regimen. An example of the Add Medication interface is illustrated in FIG. 7. Controls 7402 and 7404 are two example controls illustrated in FIG. 7, and enable the physician to alter the start and end dates of the medication.

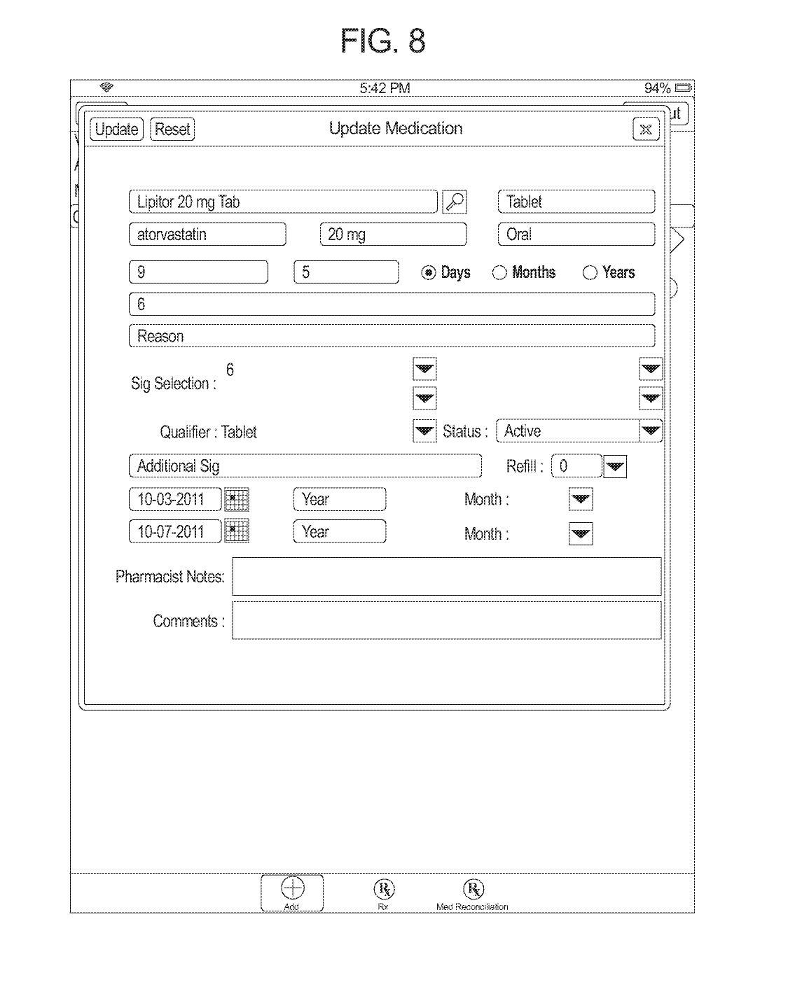

In one embodiment, the Medication interface illustrated in FIG. 6 also includes control 7302 that displays an Update Medication interface to enable the physician to update information about a medication currently being provided to a patient. An example of the Update Medication interface is shown in FIG. 8.

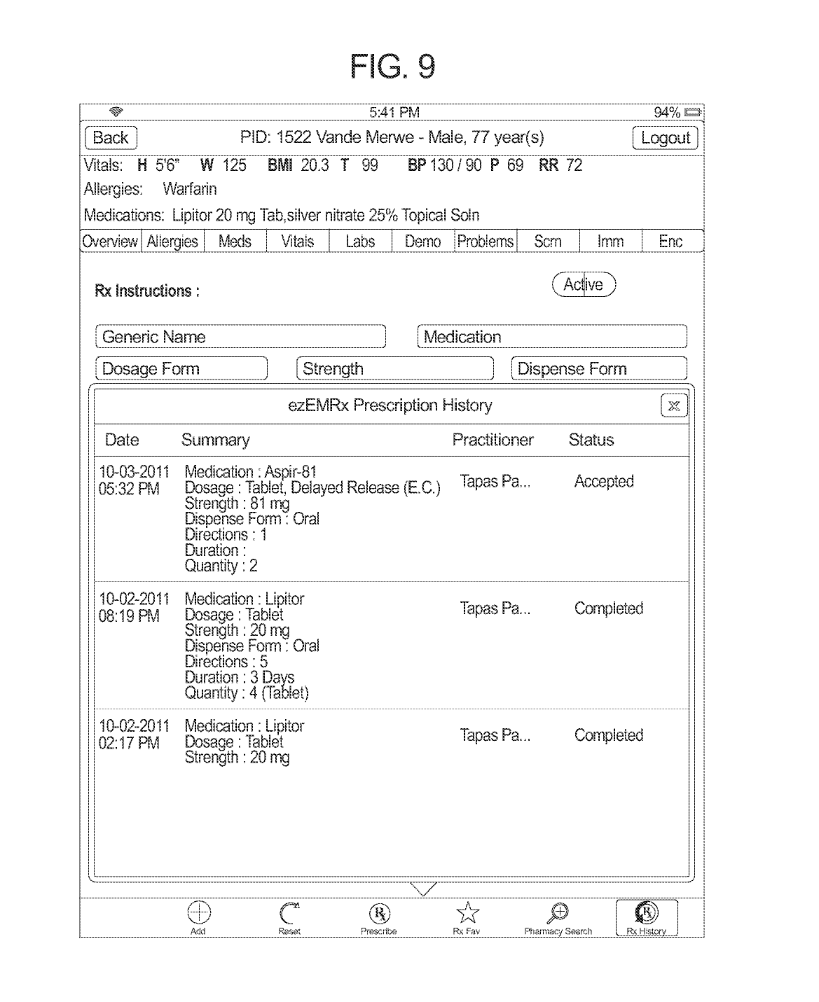

In one embodiment, the Medication Prescription interface further includes or displays an Rx History selection, which when activated causes the user device to display and enables the physician to view the patient's prescription history as generally shown in FIG. 9.

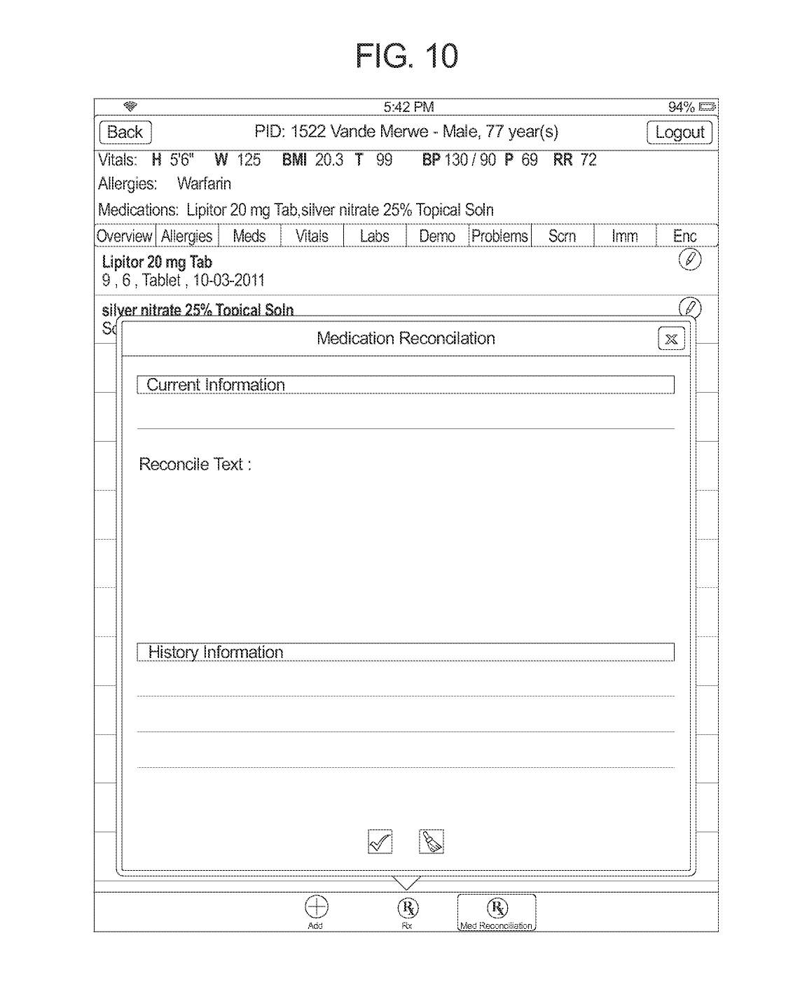

The Medication interface further includes or displays a Med Reconciliation selection 7308 as shown in FIG. 6 which when activated causes the user device to display a Medication Reconciliation interface. This Medication Reconciliation interface displays the Current Information and History Information. This Medication Reconciliation interface also provides a free text field that enables the physician to input Reconcile Text, as shown in FIG. 10.

In one embodiment, the Patient Dashboard interface includes or displays a Vitals selection, which when activated, causes the user device to display a Vitals interface. The Vitals interface enables the physician to select one or more of the following patient vitals: (i) Height, (ii) Weight, (iii) BMI, (iv) Temperature, (v) Systolic blood pressure, (vi) Diastolic blood pressure, (vii) Pulse, and (viii) Respiratory rate, by checking the check boxes adjacent to each respective vital. This Vitals interface includes a “Chart” selection 7802 which, when activated after the physician has selected (by checking) any one or more of these vitals, causes the user device to display a graph of the vitals against time.

The Patient Dashboard interface may also include or display a Labs Result Report (“Labs”) selection, which when activated, causes the user device to display a Labs Result Report interface. This Labs Result Report interface displays a list of Lab Result Reports for the patient and enables the physician to individually select each set of lab results reports. A chart selection (represented by a bar graph icon) is displayed with the lab results, which, when activated causes the user device to display a Lab Chart interface which displays a list of the specific lab results of the selected lab result report which further enables the physician to select each of the individual lab results in that selected lab result report. This Labs Chart interface also includes a Graph selection which, when activated after the physician has selected any one or more of these lab results, causes the user device to display a graph of the selected patient lab results. This graph displays the history of individual patient labs results against time.

The Patient Dashboard interface includes or displays a Demographics (“Demo”) selection, which when activated, causes the user device to display a Demographics interface which includes the patient's current demographics data. The Demographics interface includes or displays the following fields along with a recent photo of the patient (if available): (i) Alias name, (ii) Date of birth, (iii) Social security number, (iv) Email, (v) Language, (vi) Race, (vii) MPI (Master patient index), (viii) Salutation, (ix) Suffix, (x) First name, (xi) Last name, (xii) Middle name, (xiii) Gender, (xiv) Religion, (xv) Marital status, (xvi) Care location, (xvii) Ethnicity, and (xviii) CRN (Critical resource network). The Demographics interface includes Edit selection which when activated enables the physician to edit any of these fields.

The Patient Dashboard interface may include or display a Problems selection, which when activated, causes the user device to display a Problems interface which includes a scrollable list of each the patient's current problems labeled Current Problems and a scrollable list of each of the patient's previous problems labeled Problem History.

The Problem interface enables any of the listed current problems to be edited by selecting the Edit selection next to them (which is represented by a pencil icon). When any of the Edit selections are activated, the user device displays an edit interface with the same options as the “Add” interface as described below. This enables the physician to make changes and save them using the “Update” selection or clear the fields using the “Reset” selection.

The bottom of the Problems interface includes an Add selection, which when activated, causes the user device to display an Add Problem interface which enables the physician to add a new patient problem to the current patient problem list. The user device thus enables the physician to add to a list of the patient's current problems such as the patient's chronic problems.

The Add Problem interface includes a Problem Type text field and an associated drop-down menu with the following options: (a) Finding, (b) Functional limitation, (c) Diagnosis, (d) Condition, (e) Complaint, (f) Problem, and (g) Symptom.

The Add Problem interface includes or displays a Problem Code text field 8404 and an associated data dictionary function, which when characters are inputted searches a data dictionary upon selection of the search selection (represented by a magnifying glass).

The Add Problem interface includes or displays a Problem Name a text field which, when characters are inputted searches a data dictionary upon selection of the search selection (represented by a magnifying glass).

The Add Problem interface includes or displays an Onset Date text field and an associated calendar selection tool that enables the physician to easily and quickly select the onset date of this patient problem.

The Add Problem interface includes or displays a Resolved Date text field and an associated calendar selection tool which enables the physician to easy and quickly select the date that this patient problem. In one embodiment of system of the present disclosure, the user device does not require that this resolved date be inputted because the problem may still be ongoing. In one embodiment of the system of the present disclosure, if the physician inputs a resolve date, the user device: (i) automatically switches or causes this problem to be listed in the patient problem history list instead of the patient current problem list; and (ii) automatically sets the Status field (described below) to the Resolved status.

The Add Problem interface includes or displays a Comments free text field, which enables the physician to input any additional data about the problem.

The Add Problem interface includes or displays a Status field 8414 and an associated drop-down menu with the following options: (i) Active, (ii) Erroneous, (iii) Inactive, and (iv) Resolved.

In one embodiment, the Patient Dashboard interface includes or displays a Screening (“Scrn”) selection, which when activated, causes the user device to display a Screening interface which includes a scrollable list of selections for each the patient's screening alerts labeled Screening Alerts and a scrollable list of each of the patient's previous screening alerts labeled Screening History.

The bottom of the Screening interface includes or displays an Add selection, which when activated, causes the user device to display an Add Screening interface which enables the physician to add a new patient screening to the current patient screening list. The user device thus enables the physician to add to a list of the patient's screening.

The Add Screening interface includes or displays a Type text field and an associated data dictionary function, which when characters are inputted searches a data dictionary upon selection of the search selection (represented by a magnifying glass). The user device displays suggestions as a drop-down menu below the field.

One embodiment of the Add Screening interface includes or displays a Date of Screening text field and an associated calendar selection tool, which enables the physician to easily and quickly select the date of this screening.

One embodiment of the Add Screening interface includes or displays an Alert After text field followed by radial selections for Days, Months or Years.

One embodiment of the Add Screening interface includes or displays a Comments free text field, which enables the physician to input any additional data about the screening.

One embodiment of the Patient Dashboard interface includes or displays an Immunization (“1 mm”) selection, which when activated, causes the user device to display a Immunization interface which includes a scrollable list of selections for each the patient's immunization alerts labeled Immunization Alerts and a scrollable list of selections for each of the patient's previous immunization labeled Immunization History.

One embodiment of the bottom of the Immunization interface includes or displays an Add selection, which when activated, causes the user device to display an Add Immunization interface which enables the physician to add a new patient immunization to the current patient immunization.

One embodiment of the Add Immunization interface includes or displays an Immunization Type text field and an associated data dictionary function, which when characters are inputted searches a data dictionary upon selection of the search selection (represented by a magnifying glass). The user device displays suggestions as a drop-down menu below the field.

One embodiment of the Add Screening interface includes or displays a Date of Immunization text field and an associated calendar selection tool which enables the physician to easy and quickly select the date of this screening.

One embodiment of the Add Screening interface includes or displays a Time (of Immunization) text field and an associated clock selection tool, which enables the physician to easily and quickly select the time of this immunization.

One embodiment of the Add Immunization interface includes or displays a Vaccine text field and an associated data dictionary function, which when characters are inputted searches a data dictionary upon selection of the search selection (represented by a magnifying glass). The user device displays suggestions as a drop-down menu below the field. The user device also displays a checkbox to be check if the vaccine is not applicable.

One embodiment of the Add Immunization interface includes or displays an Alert After text field followed by radial selections for Days, Months or Years.

One embodiment of the Add Immunization interface includes or displays a Comments free text field that enables the physician to input any additional data about the immunization.

One embodiment of the Add Immunization interface also enables to the physician to input the data about the vaccine give to the patient. One embodiment of the Add Immunization interface includes or displays: (i) a Batch/Lot number text field which enables the physician to the Batch/Lot # of the vaccine; (ii) an expiration date text field and associated calendar selection tool which enables the physician to input the expiration date of the vaccine; (iii) a Manufacturer Name text field and an associated data dictionary function, which when characters are inputted searches a data dictionary upon selection of the search selection (represented by a magnifying glass) and where the user device displays suggestions as a drop-down menu below the field; (iv) a Site a text field which enables the physician to input the site on the patient where the vaccine was given; (v) a Route field which enables the physician to input the route administration of how the vaccine was given to the patient; (vi) two Amount text fields and an associated search selection (represented by a magnifying glass icon) which enables the physician to input the amount given to the patient; (vii) an Administered By text field which enables the physician to input the name of the person who actually gave the vaccine to the patient; and (viii) three Is Patient Allergic radial selections with the following options including: Yes, No, and Not Applicable, which enable the physician to input this allergic data. In one embodiment of system of the present disclosure, if the yes selection is marked, the user device automatically displays the Add Allergy interface to enable the physician to add the allergic reaction.

One embodiment of the Patient Dashboard interface includes or displays an Encounter (“Enc”) selection 6130, which when activated, causes the user device to display an Encounter interface which displays a list of scrollable selections for each of the patient encounter records labeled Encounter History. It should be appreciated that the list will include all of the previous encounters for the patient by the physician. It should further be appreciated that in certain embodiments of the present disclosure, the list of encounters will include encounters of the patient by one or more other physicians, and thus, a physician seeing or encountering a patient can view all of the previous encounters of that patient in an easy and quick fashion. As more physicians use the system, the databases of encounters will grow and become complete.

Additionally, as further described below, in certain embodiments, the system will import previously stored EMR and HIE systems patient records and make those accessible through the system. In most cases, these records will be imported as a CCD (continuity of care document) using the HITSP C32 standard. If the EMR or HIE system is unable to support the C32 CCD document structure, alternative embodiments of the present system may enable the parsing and re-structuring of patient records using natural language processors (“NLPs”). In this alternative embodiment, keywords are extracted using the NLP and used to select the proper codes using a standard ontology such as SNOMED-CT.

In various embodiments of the present disclosure, each of the displayed patient encounters in the list includes a display of the chief patient complaint (which was the reason for the encounter), the physician who saw the patient, and the date of the patient visit or exam. When the user selects an Encounter, the user device will display the encounter narrative. It should be appreciated that the display patient encounter can display other suitable patient data in other suitable formats in accordance with the present disclosure. It should further be appreciated that in certain embodiments of the present disclosure, the user device will enable the physician to customize what data is displayed in each patient encounter. It should also be appreciated that in certain embodiments of the present disclosure, the user device will enable the physician to cause only the display of certain types of patient encounters. For example, the user device may enable the physician to exclude dental encounters because they are not relevant to the physician. It should also be appreciated that the list of patient encounter in and of itself enables the physician to see patterns of when the patient visits physicians and which physicians the patient visits. These patterns themselves can in certain instances provide data to the physician on how to treat a patient.

One embodiment of the bottom of the Encounter interface includes a New Encounter selection 8902, which when activated, causes the user device to display an Add New Encounter interface opens the Encounter interface.

It should be appreciated from the above that Patient Dashboard interface of the present disclosure provides an intuitive, easy to use, tool for the physician to use to treat a patient, and to enter and change various data regarding the patient and the treatment of the patient. It should also be appreciated that Patient Dashboard interface may be otherwise suitably configured and/or customized by a physician.

### Alternative Interfaces

In further embodiments of the present disclosure, the app or application will connect to a single EMR or HIE system through the Application Server as shown in FIG. 1. Data can be held in escrow on Edge Servers, enabling source systems to retain control of the data they provide.

In one such alternative embodiment, illustrated in FIG. 1, the user device 10 may be controlled by a server 31, which would be a interoperable communication layer designed to communicate with multiple, disparate systems. The interoperable application server 31 in turn connects to a separate EMR system 50 or HIE system 70. In such an embodiment, Edge Servers 32 may be employed to cache the data maintained by the EMR and HIE systems.

Turning now to FIG. 11, this flowchart generally illustrates how in one example embodiment a message travels from a healthcare system (such as an EMR or HIE system) to the user device, and how data input into the user device is sent back to the appropriate healthcare system. First, the host system (e.g., the hospital) sends patient data updates to the Interface Portal Server. The healthcare system, shown in FIG. 11 as a multi-EMR hospital system, sends an HL7-formatted patient update to an EMR server such as the ezEMR Interface Portal Server. This message is sent to an EMR server such as the ezEMRx Application server. The Application Server adds the data into a patient's record in an EMR database such as the ezEMRx patient database. The user device asks the user for login information. Once this information is inputted, the Application Server validates the user. The Application server reads data from the Database Server. The Database server sends the requested information to the Application Server. The user device displays the patient data to the user. The user device sends any new or edited information back to the Application Server. The Application Server sends the new data to both the Database Server and to the Interface Portal Server. The Interface Portal Server sends the update to the hospital system. A user must then manually accept the patient data update into the host system.

Once the user chooses a system to log into, the server will determine the nature of the host system and configure the appropriate display of the interface. This configuration will determine which features are displayed, based on which aspects of the patients' records the connected system supports. If a connecting system is not able to provide a timely response to queries, an “edge” server can be installed locally to hold patient data. This data can be disconnected from the application server at the discretion of the host system. In this way, the edge server collects the patient data (either through polling or push notification from the host system) and responds to queries from the application server.

It should be appreciated that in alternative embodiments of the system of the present disclosure, the interfaces discussed above, may be varied, changed, modified, streamlined or otherwise reconfigured in accordance with the present disclosure. For example, in one alternative embodiment of the present disclosure, the user device displays the patient names and tasks side-by-side to enable easier navigation and selection by the user.

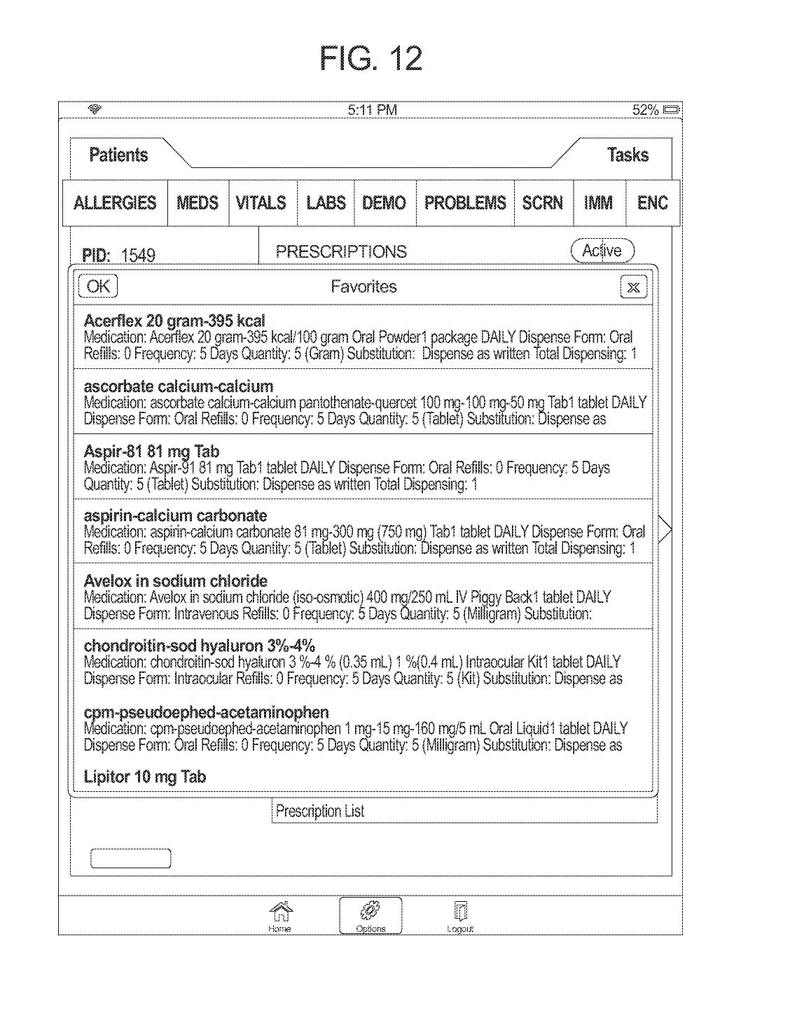

FIG. 12 illustrates an ePRESCRIPTION interface displayed in one alternative example of the disclosed system architecture. In the illustrated embodiment, the disclosed system enables the physician to specify a list of favorite prescriptions such that those prescriptions are easy accessible when needed. For example, the disclosed system may enable a physician to configure the favorite prescriptions such that cold and flu medications are part of the favorites list during cold and flu season.

It should further be appreciated that in alternative embodiments of the present system, patient billing and insurance information can be entered and accessed, providing an intuitive, easy to use, tool for the physician to enter and change various billing information regarding the patient and the treatment of the patient.

In certain embodiments, the system of the present disclosure is configured such that the interfaces are configured to provide additional context to data on display. In one example, selecting the author of an encounter in a patient record can cause the user device to display additional data on that author, such as specialty, practice location or hospital affiliation, and contact information. In another example, selecting a term can cause the user device to display a definition as provided by a data dictionary (e.g., selecting “migraine” in a record would cause a display of the entry for “migraine” in the SNOMED-CT ontology).

In certain embodiments, the system of the present disclosure is configured to collect and store data that is not currently supported by the existing EMR and HIE systems. This data can be stored separately in databases maintained by a system administrator, and later integrated into patient records if the collected data becomes a part of future health IT standards.

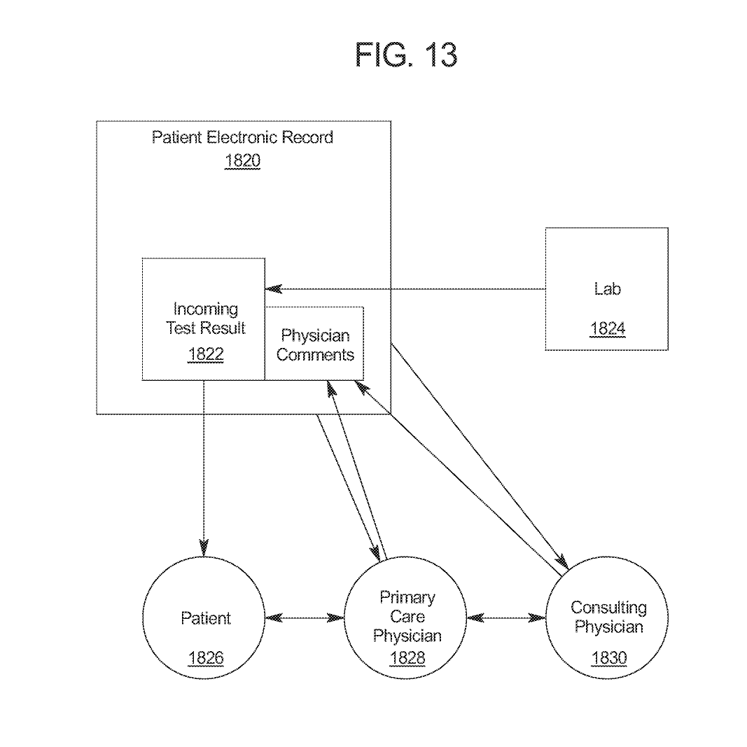

In certain embodiments, the system of the present disclosure is configured such that the interfaces are configured to enable multiple users to interact with the patient, the patient's record, and with each other. In certain embodiments, this includes, but is not limited to features such as a secured electronic chat, or instant message system, an ability to comment on objective data (e.g., patient test results) as well as subjective data (e.g., other provider's assessments or plans of care). A sample collaborative workflow for such an embodiment is generally shown in FIG. 13. As shown in FIG. 13, the electronic medical record 1820 for the Patient 1826 receives a test result 1822 from Lab 1824. The system gives the Primary Care Physician 1828 and Consulting Physician 1830 access to the entire chart, enabling the provider to see the test result in the record and make comments. The system also makes the data from the results available to the patient. The system also enables the providers to communicate directly with each other, and for the providers to communicate directly with the patient.

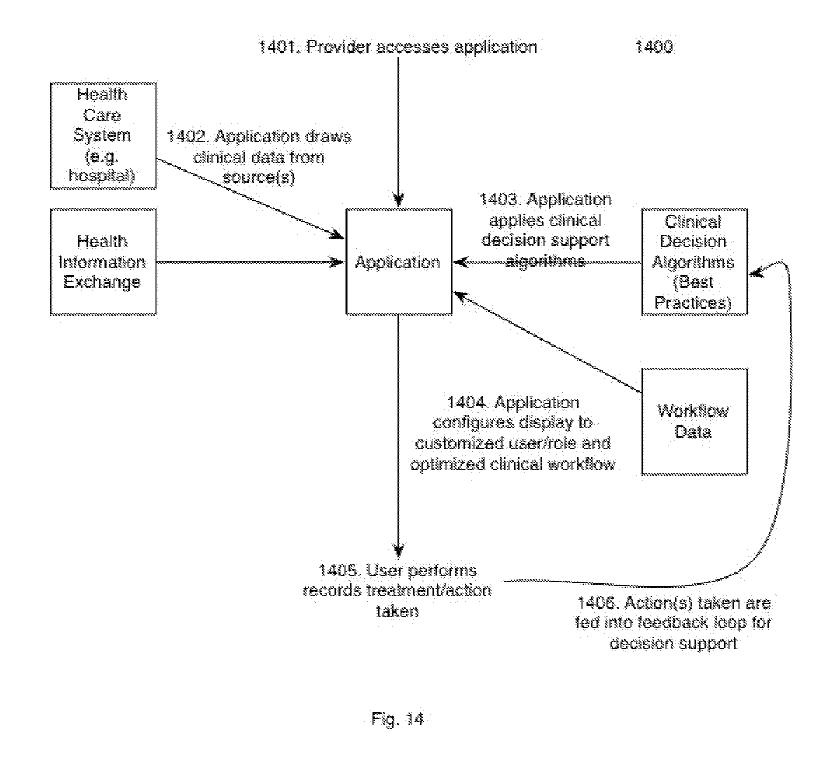

FIG. 14 is a flow diagram illustrating an example process 1400 for applying best practice decision support to clinical care. It should be appreciated that the flow diagram illustrated in FIG. 14 is exemplary; in other embodiments, the order of certain boxes can change, and certain boxes may not be present.

As illustrated in FIG. 14, the process 1400 begins with step 1401, in which a health care provider accessing the application disclosed herein, such as through a user device in the form of a tablet computer. Upon the provider accessing the application, the application draws data from one or more clinical data sources, depending on the type of information needed for the particular access by the provider, as illustrated in step 1402. As the process 1400 shows, the source of such information could be from a Health Care System device (such as a computer in a hospital), an EMR, or a Health Information Exchange, or HIE.

Upon retrieving the appropriate information from the appropriate clinical data source, the disclosed system retrieves clinical decision support algorithms from a database of clinical decision algorithms, as indicated by step 1403. In various embodiments, these algorithms reflect a set of well-established best practices defined by an appropriate body. Using the retrieved decision support algorithms, and drawing from a repository of workflow data as illustrated in FIG. 14, the process 1400 continues by configuring the display of the user device to a customized user or role based on the clinical information and decision support algorithms retrieved, as illustrated by step 1404. In one embodiment, the disclosed system causes the display of a customized user interface based on the algorithms and/or the healthcare provider's personal preferences. In another embodiment, the system causes the display of an optimized clinical workflow, generated by applying the best practices algorithms retrieved at step 1403. It should thus be appreciated that by applying clinical decision support algorithms to clinical data obtainable from multiple sources, the disclosed system enables the display of a user device to change to present information, customized to the user, including an optimized clinical workflow that follows a set of well-established best practices.

After configuring the display as described above the disclosed system enables the user to take the actions and perform the treatments suggested by the customized display, as illustrated by step 1405. In various embodiments, the system disclosed herein presents the displayed workflow not as mandatory, but as a suggestion of a possible workflow, and enables the caregiver to determine, based on his or her medical experience, whether to follow the suggested workflow or to deviate from it.

Finally, the disclosed system provides a feedback loop by providing an indication of the actions taken by the healthcare provider back in to the repository from which the clinical decision algorithms were obtained, as indicated by step 1406 of process 1400. In this embodiment, the system thus enables the continual honing of the algorithms representing best practices based on actions that various physicians have deemed appropriate in view of certain information sets. Thus, the disclosed system advantageously provides a continually updating set of algorithms, which suggests continually updating workflows to physicians, depending on the judgment and actions of clinicians faced with similar issues.

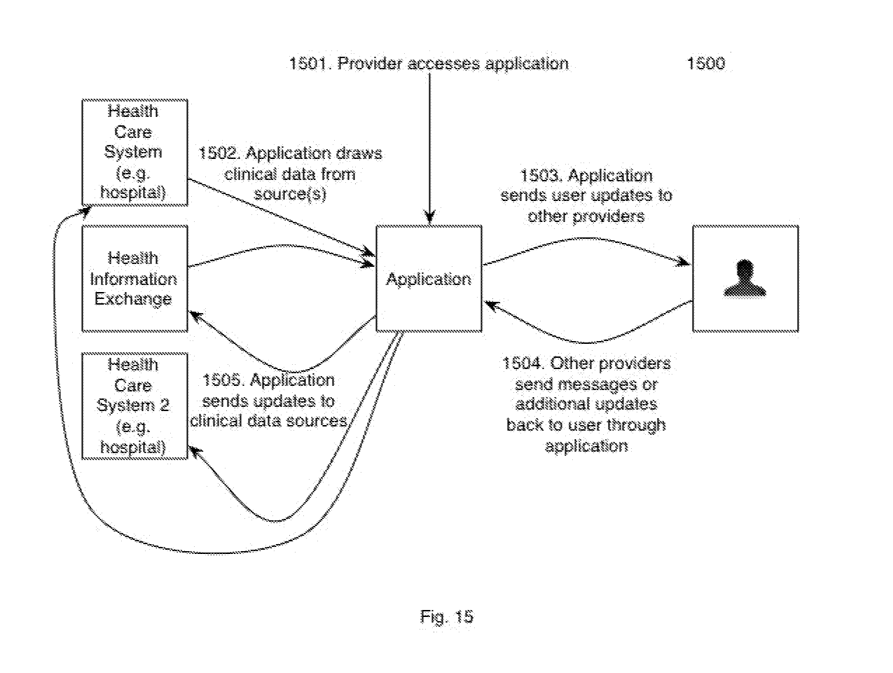

FIG. 15 illustrates an embodiment of a process 1500 for coordination and communication among healthcare providers. It should be appreciated that the flow diagram illustrated in FIG. 1500 is exemplary; in other embodiments, the order of certain boxes can change, and certain boxes may not be present.

The process 1500 of FIG. 15 begins when a health care provider accesses the application provided by the disclosed system, as indicated by step 1501. In various embodiments, the health care provider accesses the application using a user device such as a tablet computer, as described elsewhere herein. Upon accessing the application, the application disclosed herein draws clinical data from one or more clinical sources, as illustrated in step 1502. For example, the application could draw clinical data from one or more different health care systems and EMRs (such as one or more different hospitals) or health information exchanges or HIEs.

After retrieving the information required by the provider from the various clinical data sources, the application provided by the disclosed system sends user updates to other providers, as illustrated in step 1503. Specifically, the provider (or another user of the application) can update information received from clinical data sources, and upon storing such updates, the disclosed system can send the updated information to other providers. Further, the disclosed system enables other providers to send messages or additional updates to the original provider through the application, as illustrated by step 1504. Finally, upon receiving the updates to the clinical data from the other providers, the disclosed system causes the application to send the updated data back to the various clinical data sources, such as the hospital databases or the HIEs from which the data originated, as illustrated by step 1505.

By implementing the process 1500 of FIG. 15, the disclosed system enables data to be retrieved from various medical data sources, modified by the user of the disclosed application, and shared in modified form with other medical providers. The system further enables the other medical providers to further modify the modified data. Thus, the system enables multiple users to modify a single set of data, and further enables the modified data to be provided back to the original data sources from which it was retrieved. The system thus advantageously enables healthcare providers to coordinate and communicate with one another by modifying or supplementing medical data, and at the same time ensures that the most recent and/or most comprehensive version of medical data is maintained at the appropriate medical data repositories.

In one embodiment, the disclosed system advantageously enables information from disparate sources to be displayed in a unified, customizable way to a user (such as a physician or nurse) at a user device. Moreover, the disclosed system advantageously enables the extracting of certain aspects of data and applying algorithms or instructions, representative of clinical decision support algorithms or sets of best practices. In this embodiment, the disclosed system thus enables health information to drive decision support for physicians and other medical professionals. Further, in some embodiments, the disclosed system enables the communication of the various information that can be obtained from medical databases and that can be generated or synthesized by the system can be communicated among healthcare providers as part of coordinated care activity. In various embodiments, the disclosed system also enables the sending of alerts to various medical professionals, including among healthcare providers, depending on the clinical decision support algorithms applied to the extracted data. For example, if an emergency room physician treats a patient who shows signs of abnormal blood sugar levels, the disclosed system in may send an alert to the patient's primary care physician based on clinical decision support algorithms related to the condition of diabetes.

In one embodiment, the disclosed system converts certain data into more appropriate forms depending on the source and the destination of the data. For example, the system converts data extracted from various clinical data sources into actionable, workflow correspondent information through the application of algorithms and other clinical knowledge (expressed as algorithms). In one embodiment, this conversion occurs at one or more servers connected to both the user devices and the clinical data sources. By converting data as described, the disclosed system enables prompter decisions, more accurate decisions, earlier treatment initiations, more efficient processing of patients via quicker decision making, and ultimately, better patient outcomes through improved processes and treatment plans.

In certain embodiments of the present disclosure, the system is configured to cause the user device to display a comprehensive merged or aggregated electronic medical patient record. In these embodiments, regardless of the interface, the user device enables the user to access all aspects of each of a patient's electronic medical patient records, regardless of where the underlying electronic data is originally created or currently resides or is stored. In certain embodiments, when the system of the present disclosure accesses or communicates with multiple EMR systems to obtain multiple EMRs of or for a patient from those multiple EMR systems, either directly or via an HIE system, the user device will provide the user with a single interface or view of these multiple EMRs and will specify or indicated to the user the source of all patient data (i.e., each of the EMRs) so the user can understand where the patient data originates from and additionally identify any discrepancies. As described above, the user device enables the user to add any new patient data, and an update will be sent to any designated connected systems as an update. In most cases, this transfer of data would most likely be implemented using edge servers, as described above.

In certain embodiments, in addition to collecting patient data as the inputted data passes through the user device to server of the system and then to one or more EMR systems and HIE systems, the system of the present disclosure is configured such that the interfaces are provide one or more decision support tools or functionality. Using up-to-date information on best practices for patient care, the interfaces can be configured to enable the users to obtain patient data and can be configured to prompt the user with or display to the user additional information, instructions, and/or questions to ensure that they are obtaining the necessary information from their patients which in turn results in providing the best quality of care to their patients. In certain embodiments, these prompts can be provided through a link or an embedded application or app.

More specifically, in certain embodiments of the present disclosure, the user interfaces displayed by the user device assist the physician in treating patients at the time and point of treatment. In certain embodiments, the interfaces includes series or sets of required patient data input fields which prompt the user such as the physician to ask the patient questions to obtain needed data from patient. In other words, by displaying certain required data fields relating to or for the examination of the patient, the system implicitly reminds the physician to ask the patient the appropriate questions that will give the physician the answers that the physician needs to treat the patient in accordance with best practices and quality measures as well as to input data into the user device at the point of patient care and during the patient care.

In one such example, if best practices change for treating patients with diabetes where the best practice is to have the patient avoid a certain type of food, when the system is updated with this information and adjusts the interfaces accordingly. When the system determines that a physician is seeing a patient with diabetes, the system causes the user device to cause one of the interfaces to require the physician to ask the patient if they eat that type of food, and if so to inform the patient that they should not eat that type of food. Additionally, the system in this example is configured to enable the physician to easily access the exact source of that best practice such as a report from a trusted or reliable source (even before the physician knows about the report from the physician's normal procedures for keeping up with best practices). By implementing such questions and access to such reports through the interfaces, the system assist all of the healthcare providers who use the system to care for their patients in accordance with best practices, and thus has the potential to dramatically increase the level of patient care.

In certain embodiments of the present disclosure, the system analyzes the specific patient data for the patient being treated and provides feedback to the physician or other healthcare provider at the point and time of patient treatment. For example, in certain embodiments, the system analyzes one or more of: (a) known clinical data; and (b) the specific patient subjective and objective data and provides feedback in real time to the physician when the physician is treating or with the patient or shortly after the physician treats or meets with the patient. In one example, the system uses the set of inputted patient symptoms to determine and provide to the physician a set of frequent diagnoses based on the inputted patient symptoms (including objective and subjective patient data).

In certain embodiments of the present disclosure, the system determines and provides to the provider a checklist for best practices based on a chronic problem of the patient based on inputted patient data, stored patient data and other de-identified clinical data.

In certain embodiments of the present disclosure, the system presents fields for quality reporting within the patient encounter interface (described below) saving the caregiver the time and effort currently necessary to copy or re-enter this data at a later time.

In certain embodiments, the system of the present disclosure is configured to present a qualitative analysis of quantitative patient data. For example, if a recent lab result for a patient has returned a bone density that is considered to be at a dangerously low level, the patient overview would display an alert for the patient's skeletal system. This could be displayed both as text and an image, such as an outline of a human patient with systems of particular interest highlighted.

In certain embodiments of the present disclosure, the system checks certain designated requirements to determine whether the correct billing code has been applied by the physician or whether a different billing code would be more appropriate, or whether a different billing code could be used if additional requirements are met. In certain embodiments, this is done by the system as an additional layer without affecting the coded structure of the underlying patient data access and patient data input itself. In other words, the data collected by the system is de-identified (patient identifying data is removed) and stored separately from the patient data.

In certain embodiments of the present disclosure, the system also collects and uses physician or other healthcare provider data. In certain of these embodiments, the system creates and provides feedback to the system itself based on the specific steps that the healthcare provider took using the user device in caring for a patient while the healthcare provider is still treating or with the patient or after the healthcare provider has treated or met with the patient. In other words, the system analyzes one or more of: (a) the pieces of patient data that the healthcare provider viewed through the user device when treating or with the patient; (b) the patient data inputted by the healthcare provider when through the user device when treating or with the patient; and (c) the overall decisions made by the healthcare provider for treatment of the patient. Based on this data, the system provides feedback to developers, administrators, and users to determine how effectively and efficiently the system is being used. For example, if the system detects that a certain field is ignored by multiple users, the system can turn off this field if it is deemed unnecessary for patient care quality. In another example, if the system detects that a user is rapidly switching between different areas without entering any changes, it could be an indication that a user is having difficulty finding what they are looking for, and the system (or a developer or administrator of the system) can alter the displayed interfaces to make navigation easier for the user. In certain embodiments, this is done by the system as an additional layer without affecting the coded structure of the underlying patient data access and patient data input itself. In other words, the data collected by the system is de-identified (user identifying information is removed) and stored separately from the patient data.

In certain embodiments, the system of the present disclosure is configured to reconcile incomplete or conflicting information across one or more systems. For example, medication reconciliation, a growing problem in the health care industry, can be carried out by collecting medication information for a patient from one or more of the following systems: a private practice or institutional EMR or HIE system, a regional HIE, one or more local or nationwide electronic pharmacy systems, insurance provider systems, as well as a patient portal, which would enable the patient to update their medication (entering the information into the actual patient record would require validation from a health care professional). With the information from these systems, the server can create a comprehensive view of the patient's current and historical list of medications. Two systems may have the same drug listed, but using different standards, or with different dosages. The system can group the drugs to enable a user to consolidate and correct the information. Once corrected, this update can be disseminated to the host systems, provided they are capable of receiving medication updates via standard messaging protocols or proprietary APIs.

In certain embodiments, the system of the present disclosure is configured such that the interfaces are configured according to specifications for the capture of quality of care metrics (e.g., accountable care organizations) and the capture of additional third-party data streams (e.g., data from insurance providers or pharmacies). Building this feedback into the workflow will enable users to capture quality of care metrics at the point of care, rather than needing to re-enter data into additional forms. Furthermore, data that would not be required by standard EMR systems, but that is required for reporting, can be integrated to help providers to ensure that any necessary data is collected.

In certain embodiments, the system of the present disclosure is configured such that clinical data is stripped of any identifying features to be used in academic research and clinical trials. This data can in turn be subject to analysis and fed back into the system, enabling the device to make suggestions based on similar cases and known outcomes.

In certain embodiments, the system of the present disclosure can also be used as a test platform to determine and demonstrate the impact of how a simple, portable, user device that provides the interfaces of the present disclosure can enhance clinical decision making leading to improved patient outcomes and lower healthcare costs. For example, the system of the present disclosure can be employed to test the premise that a simple, portable, interoperable set of interfaces as described herein will enable rapid adoption by providers and that universal secure access to patient data will improve patient care quality, improve outcomes and reduce costs.

In another example, the system enables the patient to enter health complaints, issues, or symptoms as they occur. When the provider sees the patient at a later day and/or time, this patient data gives the provider more and possibly more accurate patient data at least as to the time line as to when a patient the complaints, issues, or symptoms occurred.

In another example, the system enables the patient to enter a list of questions, treatments, or issues they wish to discuss during the patient encounter with the healthcare provider.

The system including the servers and user devices and methods of the present disclosure further provides additional longer-term benefits for individual patient healthcare and the healthcare of the entire population. As mentioned above and described in more detail below, the present disclosure contemplates that the interfaces provided by the user devices of the present disclosure will drive evidence-based medicine with built-in decision support tools that can respond rapidly to new healthcare discoveries and other developments in healthcare. The system can also be used to provide patients with better access to their electronic health records and to empower the patients to take a more active role in their own health care using their own electronic medical records. With the set of tools used to build the provider interface, the system can be used to create a patient portal that gives the patient access to their entire electronic record, or to subsets thereof. Where appropriate, the system can also provide data entry fields for the patient to interact with and provide data to their own electronic medical records. For example, a patient may not prescribe their own medication, but the system can enable a patient to add to or edit the list of medications they currently use. While the system in various embodiments would not present this data to providers as authoritative, the system can include this patient data in the patient record which is viewed by providers. This enables the providers to understand what medication the patient believes they should or are taking and any discrepancies. This also enables multiple different treating physicians to see what each other treating physician has proscribed and whether the patient is taking each medication.

Accordingly, it should be appreciated from the above that various embodiments of the present disclosure provide: (a) a modular EMR interface built using customizable reporting and data capture tools; (b) an EMR interface that is capable of communicating with any EMR system; (c) an EMR interface that is capable of communicating with any HIE system; (d) an EMR interface that enables user-defined feedback loops, including decision support and quality reporting tools; (e) a cross-platform mobile EMR interface; and (f) an EMR interface that displays one or more customized interfaces for any given user.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A memory device which stores a plurality of instructions, which when executed by at least one processor, causes the at least one processor to operate with at least one input device and at least one display device to enable a plurality of healthcare providers to:
access linked subjective patient data for a patient, said subjective patient data obtained from one or more healthcare providers;
access linked objective patient data for the patient, said objective patient data obtained from one or more healthcare providers or one or more electronic medical record systems;
electronically communicate a developed common assessment of the subject patient's health conditions based on said subjective patient data and said objective patient data; and
electronically communicate among healthcare providers the healthcare conditions for the patient based on the common assessment.

2. The memory device of claim 1, wherein the subjective data and the objective data are obtained from different healthcare providers or medical records systems.

3. The memory device of claim 1, wherein the plurality of instructions causes the at least one processor to operate with at least one input device and at least one display device to enable a plurality of healthcare providers to electrically communicate the healthcare conditions to a healthcare professional and not to the patient.

4. A memory device which stores a plurality of instructions, which when executed by at least one processor, causes the at least one processor to operate with at least one input device and at least one display device to enable a healthcare provider to:
create one or more first customized electronic medical record system workflow interfaces that communicate specific information regarding a patient's health conditions to the healthcare provider, such information regarding the patient's health conditions synthesized from edit patient data stored on one or more internal electronic medical record system;
create one or more second customized or unique electronic medical record system workflow interfaces that communicate specific information regarding the patient's health conditions to the healthcare provider, such information regarding the patient's health conditions synthesized from patient data stored on one or more external electronic medical record systems;
obtain one or more notification reports from said workflow interfaces; and
obtain patient care decision support from said workflow interfaces.

5. The memory device of claim 4, wherein the patient health condition information is synthesized based, at least in part, on a set of clinical decision algorithms applied to the patient data stored on one or more external electronic medical record systems.

6. The memory device of claim 4, wherein the patient care decision support includes a set of recommended protocols for consideration derived from the patient health condition information.

7. The memory device of claim 4, wherein the patient care decision support includes a subset of the patient's medical history.

8. The memory device of claim 4, wherein the patient care decision support includes an indication of a potential prescription drug interaction.

9. A memory device which stores a plurality of instructions, which when executed by at least one processor, causes the at least one processor to operate with at least one input device and at least one display device to enable a third-party health information technology developer to:
communicate an output of one or more standalone or complementary workflow interface applications that access, analyze, and/or manipulate patient data stored on an internal electronic medical record system to one or more healthcare providers; and
communicate an output of one or more standalone or complementary workflow interface applications that access, analyze, and/or manipulate patient data stored on external electronic medical record systems.

10. A memory device which stores a plurality of instructions, which when executed by at least one processor, causes the at least one processor to operate with at least one input device and at least one display device to enable healthcare providers to generate and view subjective analysis of objective patient data including:
qualitative analysis of quantitative patient data; and
alerts pertaining to combination patient data collected from different electronic sources; and
increasing levels of detail concerning the objective patient data based on user inputs selecting such increasing levels of detail.

11. The memory device of claim 10, wherein the alerts include at least one indication of a potential prescription drug interaction.

12. The memory device of claim 10, wherein the plurality of instructions, when executed by the at least one processor, causes the at least one processor to operate with the at least one input device and the at least one display device to enable the healthcare providers to generate and view subjective analysis of objective patient data including the qualitative analysis of quantitative patient data in the form of a graphical display indicating a patient's new or ongoing health problems.

13. The memory device of claim 10, wherein the plurality of instructions, when executed by the at least one processor, causes the at least one processor to operate with the at least one input device and the at least one display device to enable the healthcare providers to generate and view subjective analysis of objective patient data including the alerts pertaining to combination patient data collected from different electronic sources in the form of duplicate prescriptions across multiple pharmacies.

14. The memory device of claim 10, wherein the plurality of instructions, when executed by the at least one processor, causes the at least one processor to operate with the at least one input device and the at least one display device to enable the healthcare providers to generate and view subjective analysis of objective patient data including the alerts pertaining to combination patient data collected from different electronic sources in the form of currently available results of a duplicative test order.

15. A user device comprising:
at least one processor,
at least one input device;
at least one display device; and
at least one memory device which stores a plurality of instructions, which when executed by at least one processor, causes the at least one processor to operate with at least one input device and at least one display device to enable a healthcare provider to:
electronically enter and review patient data for a patient without directly entering or reviewing said patient data into any electronic medical records system or health information exchange;
cause said patient data to be stored on one or more electronic medical records systems or health information exchanges;
access said stored patient data from said one or more of said electronic medical records systems and health information exchanges using said user device; and
electronically send said patient data to another healthcare provider such that said other healthcare provider can use another user device to access said stored patient data from said one or more of said electronic medical records systems and health information exchanges.

16. The user device of claim 15, wherein the at least one input device includes a touch screen controller, and wherein the at least one display device is connected to the touch screen controller.

17. The user device of claim 15, wherein the plurality of instructions, when executed by at least one processor, causes the at least one processor to operate with at least one input device and at least one display device to display a plurality of potential patient support recommendations based on a set of clinical decision algorithms applied to the patient data.

18. A user device comprising:
at least one processor,
at least one input device;
at least one display device; and
at least one memory device which stores a plurality of instructions, which when executed by at least one processor, causes the at least one processor to operate with at least one input device and at least one display device to enable a healthcare provider to:
electronically enter and review patient data for a patient without directly entering or reviewing said patient data into any electronic medical records system;
cause said patient data to be stored on a health information exchange without being sent through any electronic medical records system; and
access said stored patient data from said health information exchange without said patient data being sent through any electronic medical records system.

19. The user device of claim 18, which is a tablet computer or a smart phone.

20. The user device of claim 18, wherein the plurality of instructions, when executed by at least one processor, causes the at least one processor to operate with at least one input device and at least one display device to enable a healthcare provider to enable a healthcare professional to customize at least one interface based on a set of most used options for a particular situation.
